(19) United States
(12) Patent Application Publication
(10) Pub. No.: US 2026/0242672 A1
(43) Pub. Date: Aug. 20, 2026

(54) PRODUCTION AND/OR REGASIFICATION OF BIO-LNG

(71) Applicant: Iogen Corporation, Ottawa (CA)

(72) Inventor: Patrick J. Foody, Ottawa (CA)

(21) Appl. No.: 19/472,031

(22) PCT Filed: Mar. 25, 2024
(86) PCT No.: PCT/CA2024/050364

§ 371 Date: Oct. 2, 2025

Related U.S. Application Data
(60) Provisional application No. 63/494,400, filed on Apr. 5, 2023.

(51) Int. Cl. C10G 5/06; C01B 3/38; C10G 49/00; C10L 3/10; F25J 1/00

(52) U.S. Cl. CPC C10G 5/06; C01B 3/38; C10G 49/007; C10L 3/10; F25J 1/0022; C01B 2203/0233; C01B 2203/062; C01B 2203/1241; C10G 2300/1033; C10G 2300/42; C10L 2200/0469

(57) ABSTRACT

A method of producing liquefied renewable natural gas (bio-LNG) that includes withdrawing gas comprising fossil natural gas and renewable natural gas from at least one natural gas pipe system. A first portion of the withdrawn gas is liquefied. A second portion of the withdrawn gas is used to generate heat and/or power, at least some of which is used in the liquefaction process. The renewable natural gas is distributed disproportionately between the first and second portions so as to (i) increase a quantity of the bio-LNG produced relative to when the renewable natural gas is distributed proportionately between the first and second portions and/or (ii) reduce a carbon intensity of the bio-LNG produced relative to when the renewable natural gas is distributed proportionately between the first and second portions.

### TECHNICAL FIELD

The present disclosure relates generally to the production of liquefied renewable natural gas (bio-LNG), regasification of bio-LNG, and/or a process of producing one or more products (e.g., fuels) that includes producing and/or regasifying bio-LNG.

### BACKGROUND

Liquefied natural gas (LNG) refers to natural gas that has been cooled down to liquid form, typically to about −161.5° C. The resulting cold liquid can be stored and/or transported at about atmospheric pressure in cryogenic containers (e.g., special highly insulated containers). Although capital and energy intensive, the liquefaction process reduces the volume of the natural gas (e.g., by a factor of about 600), and thus increases the efficiency of storage and/or transport.

LNG is often produced to simplify the transport of natural gas from its source to some destination across the ocean (e.g., as part of an LNG supply chain). For example, a common LNG supply chain includes the following processes: (a) extraction and processing of natural gas from fossil reserves, (b) liquefaction of the processed natural gas, (c) transport of the LNG across the ocean (e.g., via LNG carrier), (d) regasification of the LNG, and (e) distribution of the regasified LNG via natural gas pipeline.

LNG can also be produced to improve the reliability of a natural gas pipeline. For example, a peak-shaving plant located near a natural gas pipeline can produce and store LNG that is regasified in order to meet peak demand needs. Alternatively, LNG can be transported to a satellite plant that regasifies LNG for injection into a natural gas pipeline (e.g., to meet peak demand needs).

LNG is also produced to supply natural gas and/or LNG to remote locations and/or for use as transportation fuel. For example, LNG can be transported and stored for use industrial, agricultural, or mining operations (e.g., to be used for heat and power generation, as feedstock for a production process, or to fuel operating equipment such as gas and oil drilling equipment, compressors, etc.). Alternatively, LNG can be provided to a refueling station (e.g., to fuel road vehicles, ships, locomotives, and/or aircraft). For example, LNG can be used to fuel various heavy-duty vehicles (e.g., refuse haulers, grocery delivery trucks, transit buses, and/or coal miner lifters).

It is also possible to liquefy renewable natural gas (RNG). Liquefied renewable natural gas, also referred to as bio-LNG herein, is a biofuel that is generally associated with reduced carbon emissions relative to LNG produced from fossil resources (i.e., fossil-LNG). In theory, bio-LNG can be used for the same applications as fossil-LNG (e.g., as fuel for ships or heavy-duty road vehicles, or to increase the efficiency of storage and/or transport of the gas). However, the reasons for and/or economics of producing bio-LNG can be different from those for producing fossil-LNG. Typically, the facilities that produce fossil-LNG are located near a source of fossil natural gas (e.g., natural gas pipeline, natural gas field, or oil well) and are constructed to facilitate large-scale operations. In contrast, RNG is often produced on a relatively small scale and/or in rural areas (e.g., at farms). The technology for large-scale fossil-LNG production is not necessarily suitable for small-scale, decentralized production of bio-LNG. Furthermore, RNG can have a limited supply, is often produced far from LNG end-users or providers (e.g., LNG port terminals), and/or can be expensive relative to fossil natural gas. Such factors can be a deterrent to producing bio-LNG and/or can limit the practical applications for bio-LNG.

### SUMMARY

The present disclosure describes method(s) and/or system(s) of producing bio-LNG that can improve the process and/or increase the practical applications of bio-LNG. For example, by producing bio-LNG at a facility that also produces fossil-LNG, the economic advantages of large-scale production and/or the infrastructure established for the fossil-LNG, can be exploited. What is more, although RNG may be in limited supply, various method(s) and/or system(s) of the instant disclosure can increase the quantity of bio-LNG produced for a given quantity of RNG (i.e., increase the yield of bio-LNG produced) and/or reduce the carbon intensity of the bio-LNG produced for a given quantity of RNG.

Additionally, or alternatively, the present disclosure also describes method(s) and/or system(s) of producing RNG derived from bio-LNG (e.g., vaporized RNG) that can increase the quantity of RNG derived from bio-LNG and/or reduce the carbon intensity of the RNG derived from bio-LNG.

Further alternatively, or additionally, if the bio-LNG (or RNG derived from bio-LNG) is used for producing another product (e.g., is a precursor to another product such as fuel), then various method(s) and/or system(s) of the instant disclosure can increase the yield of renewable product or increase the yield of renewable content of the product produced, and/or can reduce the carbon intensity of the product, or at least the renewable content thereof, produced from a certain quantity of RNG. In producing a larger quantity of bio-LNG (or RNG derived from bio-LNG), and/or in producing bio-LNG (or RNG derived from bio-LNG) having a lower carbon intensity, the bio-LNG, RNG derived from bio-LNG, or product produced therefrom can be eligible for more and/or relatively high value credits, thereby further improving economics. In some embodiments, in producing bio-LNG having a lower carbon intensity, the bio-LNG, or product produced using the bio-LNG, can become eligible as a qualifying renewable fuel.

In accordance with one aspect of the instant invention there is provided a method of producing liquefied renewable natural gas, the method comprising: withdrawing gas from at least one natural gas pipe system, the gas comprising fossil natural gas and renewable natural gas; providing a first portion of the withdrawn gas to be liquefied; providing a second portion of the withdrawn gas for generating heat, power, or a combination thereof; and subjecting the first portion to a liquefaction process, thereby producing liquefied gas, at least some of the heat, power, or combination thereof generated from the second portion used in the liquefication process, wherein the first portion comprises at least some of the renewable natural gas such that the liquefied gas comprises liquefied renewable natural gas, wherein the renewable natural gas is distributed disproportionately between the first and second portions, and wherein the disproportionate distribution: (i) increases a quantity of the liquefied renewable natural gas produced relative to when the renewable natural gas is distributed proportionately between the first and second portions, (ii) reduces a carbon intensity of the liquefied renewable natural gas produced relative to when the renewable natural gas is distributed proportionately between the first and second portions, or (iii) a combination of (i) and (ii).

In accordance with one aspect of the instant invention there is provided method of providing renewable natural gas, the method comprising: obtaining liquefied gas, the liquefied gas comprising liquefied renewable natural gas and liquefied fossil natural gas; providing a first portion of the liquefied gas to be vaporized; providing a second portion of the liquefied gas for generating heat, power, or a combination thereof; subjecting the first portion to a regasification process, thereby producing vaporized gas, at least some of the heat, power, or combination thereof generated from the second portion used in the regasification process, the first portion comprising at least some of the liquefied renewable natural gas such that the vaporized gas produced comprises renewable natural gas; and distributing the liquefied renewable natural gas disproportionately between the first and second portions, and wherein distributing the liquefied renewable natural gas disproportionately between the first and second portions includes distributing the liquefied renewable natural gas such that: (i) the first portion has a different renewable fraction than the second portion, (ii) the first portion has a different carbon intensity than the second portion, or (iii) a combination of (i) and (ii).

In accordance with one aspect of the instant invention there is provided a method of providing product, the method comprising: determining a supply chain for providing liquefied renewable natural gas or vaporized renewable natural ga to an end user, the supply chain including: (i) sourcing upgraded biogas that is introduced into a first natural gas pipe system, (ii) producing liquefied renewable natural gas using renewable natural gas associated with one or more environmental attributes of the upgraded biogas, (iii) optionally transporting the liquefied renewable natural gas, (iv) optionally producing vaporized renewable natural gas using the liquefied renewable natural gas in a regasification process, the vaporized renewable natural gas associated with the one or more environmental attributes of the upgraded biogas, and (v) optionally introducing the vaporized renewable natural gas into the first natural gas pipe system or a second other natural gas pipe system and withdrawing renewable natural gas from the respective natural gas pipe system, the withdrawn renewable natural gas associated with the one or more environmental attributes of the upgraded biogas; and producing product associated with the environmental attributes of the upgraded biogas, the product being the liquefied renewable natural gas or vaporized renewable natural gas provided to the end user, or being product produced using the liquefied renewable natural gas or vaporized renewable natural gas provided to the end user, wherein the renewable natural gas used to produce the liquefied renewable natural gas in (ii), the liquefied renewable natural gas optionally transported in (iii), the liquefied renewable natural gas optionally provided to the regasification (iv), the vaporized renewable natural gas optionally produced in (iv), or any combination thereof, is distributed disproportionately between: (a) a supply chain portion of the corresponding fluid, and (b) a fuel portion of the corresponding fluid.

In accordance with one aspect of the instant invention there is provided a method of providing product, the method comprising: determining a supply chain for providing liquefied renewable natural gas or vaporized renewable natural gas to an end user, the supply chain including: (i) sourcing upgraded biogas that is introduced into a first natural gas pipe system, (ii) producing liquefied renewable natural gas using renewable natural gas associated with one or more environmental attributes of the upgraded biogas, and (iii) optionally producing vaporized renewable natural gas using the liquefied renewable natural gas in a regasification process, the vaporized renewable natural gas associated with the one or more environmental attributes of the upgraded biogas; and producing product associated with the environmental attributes of the upgraded biogas, the product being the liquefied renewable natural gas or vaporized renewable natural gas provided to the end user, or being product produced using the liquefied renewable natural gas or vaporized renewable natural gas provided to the end user, wherein the renewable natural gas used to produce the liquefied renewable natural gas in (ii), the liquefied renewable natural gas optionally provided to the regasification in (iv), or any combination thereof, is distributed disproportionately between: (a) a supply chain portion of the corresponding fluid, and (b) a fuel portion of the corresponding fluid.

In accordance with one aspect of the instant invention there is provided a method of producing liquefied renewable natural gas, the method comprising: withdrawing gas from at least one natural gas pipe system, the gas comprising renewable natural gas and fossil natural gas; providing a first portion of the withdrawn gas to be liquefied; providing a second portion of the withdrawn gas for generating heat, power, or a combination thereof; subjecting the first portion to a liquefaction process, thereby producing liquefied gas, at least some of the heat, power, or combination thereof generated from the second portion used in the liquefication process, the first portion comprising at least some of the renewable natural gas such that the liquefied gas produced comprises liquefied renewable natural gas; and distributing the renewable natural gas between the first and second portions such that the first portion has at least one characteristic that is distinct from that of the second portion, the at least one characteristic including at least one of renewable fraction or carbon intensity of the renewable natural gas therein.

In accordance with one aspect of the instant invention there is provided a method of producing product, the method comprising: producing the product from a production process that uses renewable hydrogen, the renewable hydrogen produced from a hydrogen production process comprising methane reforming, at least some of a methane-containing fluid fed to the methane reforming produced in a process comprising: (a) withdrawing gas from at least one natural gas pipe system, the gas comprising renewable natural gas and fossil natural gas; (b) providing a first portion of the withdrawn gas to be liquefied; (c) providing a second portion of the withdrawn gas for generating heat, power, or a combination thereof; (d) subjecting the first portion to a liquefaction process, thereby producing liquefied gas, at least some of the heat, power, or combination thereof generated from the second portion used in the liquefication process, the first portion comprising at least some of the renewable natural gas such that the liquefied gas produced comprises liquefied renewable natural gas; and (e) distributing the renewable natural gas disproportionately between the first and second portions such that: (i) the first portion has a different renewable fraction than the second portion, (ii) the first portion has a different carbon intensity than the second portion, or (iii) a combination of (i) and (ii).

In accordance with one aspect of the instant invention there is provided a method of producing fuel, the method comprising: producing fuel from a fuel production process that comprises hydrogenating crude-oil derived liquid hydrocarbon in one or more hydroprocessing units using renewable hydrogen, the fuel having renewable content, the renewable hydrogen produced from a hydrogen production process comprising methane reforming, at least some of a methane-containing fluid fed to the methane reforming produced in a process comprising: (a) withdrawing gas from at least one natural gas pipe system, the gas comprising renewable natural gas and fossil natural gas; (b) providing a first portion of the withdrawn gas to be liquefied; (c) providing a second portion of the withdrawn gas for generating heat, power, or a combination thereof; (d) subjecting the first portion to a liquefaction process, thereby producing liquefied gas, at least some of the heat, power, or combination thereof generated from the second portion used in the liquefication process, the first portion comprising at least some of the renewable natural gas such that the liquefied gas produced comprises liquefied renewable natural gas; and (e) distributing the renewable natural gas disproportionately between the first and second portions, wherein the renewable natural gas has a carbon intensity sufficiently high that the renewable content is not eligible for one or more credits when the renewable natural gas is distributed proportionately between the first and second portions, and wherein the disproportionate distribution is selected to reduce lifecycle greenhouse (GHG) emissions of the renewable content to an extent that the renewable content is eligible for the one or more credits.

In accordance with one aspect of the instant invention there is provided a method of producing hydrogen, the method comprising: feeding a methane-containing fluid to methane reforming to producing the hydrogen, wherein at least part of the methane-containing fluid is associated with liquefied renewable natural gas produced in a process comprising: (a) withdrawing gas from at least one natural gas pipe system, the gas comprising renewable natural gas and fossil natural gas; (b) providing a first portion of the withdrawn gas to be liquefied; (c) providing a second portion of the withdrawn gas for generating heat, power, or a combination thereof; (d) subjecting the first portion to a liquefaction process, thereby producing liquefied gas, at least some of the heat, power, or combination thereof generated from the second portion used in the liquefication process, the first portion comprising at least some of the renewable natural gas such that the liquefied gas produced comprises the liquefied renewable natural gas; and (e) distributing the renewable natural gas disproportionately between the first and second portions such that: (i) the first portion has a different renewable fraction than the second portion, (ii) the first portion has a different carbon intensity than the second portion, or (iii) a combination of (i) and (ii).

### BRIEF DESCRIPTION OF THE DRAWINGS

Further features and advantages of the present disclosure will become apparent from the following detailed description, taken in combination with the appended drawing, in which like features are identified by like reference numerals, and in which:

FIG. 1 is a simplified process flow diagram of one embodiment of the instant disclosure, and

FIG. 2 is a simplified process flow diagram of another embodiment of the instant disclosure.

### DETAILED DESCRIPTION

Bio-LNG and fossil-LNG are commonly produced independently (e.g., at locations close to their respective sources) and typically have distinct carbon intensities (CIs). For example, fossil-LNG can have a carbon intensity of about 88 gCO₂e/MJ, whereas the carbon intensity of bio-LNG is generally much lower (e.g., bio-LNG produced from dairy manure can have a carbon intensity of about −283 gCO₂e/MJ as a result of avoided GHG emissions).

In contrast, the instant disclosure describes method(s) and/or system(s) that include producing liquefied gas and/or regasifying liquefied gas (i.e., producing vaporized gas), wherein the feed for the liquefaction and/or regasification has a renewable component (e.g., RNG or bio-LNG, respectively) and a non-renewable component (e.g., fossil natural gas or fossil-LNG, respectively). For example, in some embodiments, one or more consignments of RNG are provided for use at a liquefaction facility configured to produce fossil-LNG.

In general, fossil-LNG and/or bio-LNG supply chains are considered to be energy intensive. For example, in some cases, about 5-20% of the total methane-containing feed provided for liquefaction (calculated based on energy) will be combusted to provide heat and/or power used in the liquefaction process. The instant disclosure describes various method(s) and/or system(s) that can reduce yield loss associated with using part of the RNG that is sourced (or bio-LNG or vaporized RNG obtained therefrom) to produce heat and/or power used within the supply chain (e.g., within the liquefaction, transport, and/or regasification). The instant disclosure also describes various method(s) and/or system(s) that can alternatively, or additionally, reduce the carbon intensity of the bio-LNG, RNG derived from the bio-LNG, or product produced using the bio-LNG or RNG derived from the bio-LNG. Advantageously, this can be achieved by distributing the RNG, bio-LNG produced from the RNG, and/or RNG derived from the bio-LNG, disproportionately between (a) feedstock and (b) fuel.

In some embodiments, the RNG provided for liquefaction is distributed disproportionately between: (a) feedstock for liquefaction, and (b) fuel for producing heat and/or power used for the liquefaction process. Advantageously, this can increase a quantity of bio-LNG produced from a given amount of RNG (i.e., increase the yield of bio-LNG) and/or reduce a carbon intensity of the bio-LNG produced from a given amount of RNG, relative to a proportionate distribution. Such embodiments are particularly advantageous for reducing yield loss of bio-LNG (e.g., resulting from the diversion of a portion of the RNG for producing heat and/or power for the liquefaction process), as the liquefaction process is energy intensive.

In some embodiments, the bio-LNG provided for regasification is distributed disproportionately between: (a) feedstock for regasification, and (b) fuel for producing heat and/or power used in the regasification process. Advantageously, this can increase a quantity of vaporized RNG produced from a given quantity of bio-LNG, and/or reduce a carbon intensity of the vaporized RNG produced from a given quantity of bio-LNG. In general, the portion of the bio-LNG used as fuel can be in gas form (e.g., can be collected as boil-off).

In some embodiments, the bio-LNG being transported is distributed disproportionately between: (a) feedstock for regasification, and (b) fuel for producing heat and/or power used in the transport process. For example, a portion of the bio-LNG being transported (e.g., the boil off) may be designated as fuel used in the transport.

Additionally, or alternatively, if the bio-LNG and/or vaporized RNG is used to produce product, the method(s) and/or system(s) can: (a) increase a renewable content of the product or increase an amount of renewable product produced, for a given amount of RNG provided to produce the bio-LNG, and/or (b) reduce a carbon intensity of the renewable content or renewable product for a given amount of RNG provided to produce the bio-LNG.

### Renewable Natural Gas

In general, the renewable natural gas (RNG) is associated with one or more processes wherein biomass is converted to biogas, and wherein the biogas is upgraded to produce upgraded biogas (e.g., RNG).

The term “biomass”, as used herein, refers to organic material originating from plants, animals, or micro-organisms (e.g., including plants, agricultural crops or residues, municipal wastes, and algae). Biomass is a renewable resource, which can be naturally replenished on a human timescale, and which can be used to produce bioenergy and/or biofuels (e.g., biogas).

The term “biogas”, as used herein, refers to a methane rich gas mixture produced from biomass. While biogas is predominately produced from the anaerobic digestion (AD) of biomass, it is also possible to produce biogas from the gasification of biomass. For example, the gasification of biomass can produce syngas, which can be cleaned up, and methanated. When produced from the anaerobic digestion of biomass, raw biogas typically includes methane (CH₄), carbon dioxide (CO₂), and can contain water (H₂O), nitrogen (N₂), hydrogen sulfide (H₂S), ammonia (NH₃), oxygen (O₂), volatile organic compounds (VOCs), and/or siloxanes, depending on its source. The term “biogas,” as used herein, can refer to raw biogas, cleaned biogas, or upgraded biogas, unless indicated otherwise.

The term “raw biogas”, as used herein, refers to biogas as obtained from its source (e.g., anaerobic digester or landfill) before it is treated to remove any chemical components (e.g., CO₂, H₂O, H₂S, O₂, NH₃, VOCs, siloxanes, and/or particulates). Raw biogas can be subjected to biogas cleaning to produce cleaned biogas or subjected to biogas upgrading to produce upgraded biogas.

The term “biogas cleaning”, as used herein, refers to a process where biogas (e.g., raw biogas) is treated to remove one or more components (e.g., H₂O, H₂S, O₂, NH₃, VOCs, siloxanes, and/or particulates), but does not remove a significant amount of CO₂ and/or N₂ (e.g., the calorific value of the biogas may not change significantly as a result of biogas cleaning).

The term “biogas upgrading”, as used herein, refers to a process where biogas (e.g., raw or cleaned biogas) is treated to remove one or more components (e.g., CO₂, N₂, H₂O, H₂S, O₂, NH₃, VOCs, siloxanes, and/or particulates), wherein the treatment increases the calorific value of the biogas. For example, biogas upgrading typically includes removing CO₂ and/or N₂. Biogas upgrading, which can include biogas cleaning, produces upgraded biogas. The term “upgraded biogas”, as used herein, can refer to partially purified biogas (i.e., requires further treatment in order to meet applicable specifications) or fully upgraded biogas (i.e., RNG).

The term “renewable natural gas” or “RNG” refers to: (1) biogas that has been upgraded to meet or exceed applicable specifications (e.g., pipeline specifications and/or compressed natural gas (CNG) specifications), and/or (2) natural gas withdrawn from a natural gas pipe system that is treated as having the environmental attributes of upgraded biogas injected into the natural gas pipe system (e.g., a gas that is treated as RNG under applicable regulations). With regard to (1), pipeline specifications, which can include specifications required for biogas for injection into the pipeline, may vary by region and/or country in terms of value and units. For example, pipeline specifications may require the upgraded biogas to have a methane content that is at least 95% or have a heating value of at least 950 BTU/scf. With respect to (2), since the transfer or allocation of the environmental attributes of the upgraded biogas injected into a natural gas pipe system to gas withdrawn from the natural gas pipe system (e.g., at a different location) is typically recognized, the withdrawn gas is recognized as upgraded biogas and/or can be treated as upgraded biogas under applicable regulations (e.g., even though the withdrawn gas may not contain actual molecules from the original biomass and/or contains methane from fossil sources). Such transfer may be carried out on a displacement basis, where transactions within the natural gas pipe system involve a matching and balancing of inputs and outputs (e.g., in MJ). Typically, the direction of the physical flow of gas is not considered.

The term “environmental attributes”, as used herein with regard to a specific material (e.g., upgraded biogas), refers to any and all attributes related to the material, including all rights, credits, benefits, or payments, that are associated with the renewable nature of the material and/or the reduction in or avoidance of fossil fuel consumption or reduction in lifecycle GHG gas emissions associated with the use of the material. Some non-limiting examples of environmental attributes include verified emission reductions, voluntary emission reductions, offsets, allowances, credits, avoided compliance costs, emission rights and authorizations, certificates, voluntary carbon units, under any law or regulation, or any emission reduction registry, trading system, or reporting or reduction program for GHG gas emissions that is established, certified, maintained, or recognized by any international, governmental, or nongovernmental agency.

The term “natural gas pipe system”, as used herein, refers to a single pipe or interconnected network of pipes (i.e., physically connected) configured for conveying natural gas and/or RNG (e.g., to one or more users). For example, a natural gas pipe system can be a natural gas grid, or any part thereof, and can include transmission pipelines, distribution pipelines, and/or any auxiliary equipment such as control and metering equipment. A natural gas pipe system can be owned by a single entity or multiple entities and can, but does not necessarily, cross provincial, state, and/or country borders.

The term “natural gas” or “fossil natural gas”, as used herein, refers to a methane rich gas mixture that is a non-renewable resource (e.g., a fossil fuel). Fossil natural gas can be found in underground geological formations, often alongside other fossil fuels like coal and oil (petroleum). For example, fossil natural gas can be extracted from a crude oil well (associated gas), or from a subterranean gas-bearing formation (non-associated gas). The composition of natural gas can vary depending on its source. For example, while fossil natural gas typically contains methane as the primary component (e.g., often greater than about 85% methane), it often contains smaller amounts of higher alkanes (e.g., ethane, propane and/or butane), as well as nitrogen, carbon dioxide and traces of other gases. Before natural gas is used as a fuel, in a manufacturing process, or transported via a natural gas pipe system, it is typically processed to remove impurities such as water. The percentages used to quantify gas composition and/or a specific gas content, as used herein, are expressed as mol %, unless otherwise specified. More specifically, they are expressed by mole fraction at standard temperature and pressure (STP), which is equivalent to volume fraction.

In some embodiments, some or all of the RNG is associated with a process wherein biomass is converted to biogas via anaerobic digestion of the biomass. Anaerobic digestion refers to the biological breakdown of organic matter by anaerobic microorganisms, is typically conducted in anaerobic or low oxygen conditions, and may involve a series of microorganism types and processes (e.g., hydrolysis, acidogenesis, acetogenesis, and methanogenesis). In general, the anaerobic digestion of biomass can be conducted in any suitable environment, including a natural environment (e.g., a landfill) or a controlled environment (e.g., one or more anaerobic digester reactors arranged in series and/or in parallel). Each anaerobic digester can be a holding tank, or another contained volume, such as a covered lagoon or sealed structure, configured to facilitate the anaerobic digestion and collection of biogas. The raw biogas produced from the anaerobic digestion, which can have a significant carbon dioxide content (e.g., about 35%), can then be subjected to biogas cleaning and/or upgrading to produce upgraded biogas.

In some embodiments, some or all of the RNG is associated with a process wherein biomass is converted to biogas via one or more thermochemical processes (e.g., gasification of biomass or pyrolysis of biomass). Gasification is a process that converts organic and/or fossil-based carbonaceous materials at high temperatures (>700° C.), without combustion, with a controlled amount of oxygen and/or steam into syngas (i.e., a gas mixture primarily composed of hydrogen and carbon monoxide, and sometimes carbon dioxide). The syngas, which may be treated to remove one or more components, can then be subjected to methanation, to produce a methane-rich gas. This biogas can be upgraded (e.g., carbon dioxide removed) to produce upgraded biogas.

In general, the biogas upgrading can be conducted using any suitable technology or combination of technologies that can separate the methane from one or more non-methane components in the biogas (e.g., separate CH₄ from CO₂, N₂, H₂S, H₂O, NH₃, O₂, VOCs, siloxanes, and/or particulates). For example, biogas upgrading technologies are often based on absorption, adsorption, membrane separation, and/or cryogenic separation. As will be appreciated by those skilled in the art, the technology used for the biogas upgrading can be dependent on the composition of the biogas and the desired purity of the upgraded biogas. In some embodiments, the biogas upgrading provides a methane-rich gas having a methane content of at least 90% (e.g., of at least 90%, at least 91%, at least 92%, at least 93%, at least 94%, at least 95%, at least 96%, at least 97%, or at least at least 98%). It can be particularly advantageous to produce upgraded biogas having a methane content that facilitates injection into a natural gas pipe system (e.g., after adding gas having a relative high heating value, such as propane, if required).

In general, the RNG can be associated with one or more types of biomass feedstocks. For example, some examples of biomass that can be suitable as feedstock for producing the RNG include: (i) energy crops (e.g., switchgrass, sorghum, etc.); (ii) residues, byproducts, or waste from the processing of plant material in a facility, or feedstock derived therefrom (e.g., sugarcane bagasse, sugarcane tops/leaves, corn stover, etc.); (iii) agricultural residues (e.g., wheat straw, corn cobs, barley straw, corn stover, etc.); (iv) forestry material; (v) livestock manure, including swine and cow manure; (vi) food scraps and/or agrifood processing residues (e.g., from slaughterhouse), and/or (vii) municipal waste or components removed or derived from municipal waste. These examples of suitable biomass are advantageous in that they do not compete with food production. In some embodiments, the biomass is a fibrous biomass (e.g., straw). In some embodiments, the biomass includes food scraps and/or agrifood processing residues. In some embodiments, the biomass includes livestock manure (e.g., swine or cattle manure).

In some embodiments, biogas is processed to produce RNG, and some or all of the RNG is injected into a natural gas pipe system (e.g., to be transported as a fungible batch). For example, in some embodiments, a quantity of RNG (e.g., MJ) is injected into a natural gas pipe system, an equivalent quantity of gas (e.g., MJ) is withdrawn at or near the liquefaction facility, and environmental attributes of the injected RNG are transferred to the withdrawn gas such that the withdrawn gas can be treated as RNG under applicable regulations and provided for the liquefaction process.

In some embodiments, the RNG provided for the liquefaction process contains multiple RNGs (e.g., multiple batches of RNG and/or multiple consignments of RNG). For example, in some embodiments, the RNG includes multiple consignments of RNG injected into a natural gas pipe system at a different injection points. In some embodiments, the RNG includes one or more consignments of RNG injected into the natural gas pipe system at a centralized injection point.

In general, when the RNG provided for the liquefaction process contains multiple RNGs (e.g., multiple batches of RNG and/or multiple consignments of RNG), each RNG will be associated with a different biogas source, a different type of feedstock (e.g., manure, wastewater, agricultural residues, source separated organics, etc.), a different carbon intensity, a different production process, and/or different sustainability characteristics, than each of the other RNGs. For example, the multiple RNGs can be sourced from different biogas producers from different types of processes (e.g., different pathways).

In some embodiments, the RNG provided for the liquefaction process includes at least two batches of RNG that differ in terms of their biogas source. A biogas source, which generally refers to the point of origin of the biogas used to produce the RNG, can include, but is not limited to, a farm having one or more anaerobic digesters, a landfill, and/or a gasification plant. Each biogas source can produce a single biogas, which has a single carbon intensity and/or is derived from a single type of feedstock, or can produce multiple biogases, each of which has a different carbon intensity and/or is from a different feedstock. For example, an anaerobic digester can process feedstock containing manure and straw. In this case, the biogas produced can be nominally divided into a first biogas produced from a manure feedstock and a second biogas produced from a straw feedstock, in a ratio determined at least in part by feedstock inputs. Although produced from the same biogas source (e.g., anaerobic digester), the different biogases can have different carbon intensities and/or sustainability characteristics.

In some embodiments, the RNG provided for the liquefaction process includes at least two batches of RNG that differ in terms of the feedstock from which they are derived. RNG derived from different feedstocks may qualify for different credits under certain regulations. For example, the United States Environmental Protection Agency (EPA) allows RNG produced from landfill gas to qualify for cellulosic biofuel D3 RINs, whereas RNG derived from non-cellulosic feedstocks like fats, oils, sugars, starches, and most food wastes typically qualifies for D5 RINs. In addition, different types of feedstocks may have different sustainability characteristics. For example, energy crops (e.g., low-cost and low-maintenance crops grown solely for energy production rather than food) may be associated with potential land-use impacts and/or may require fertilizer produced from fossil fuels. The production of RNG from feedstock that is based on waste such as livestock manure or food scraps can prevent methane from being released to the atmosphere that otherwise would escape to the atmosphere as it decomposed, and thus may be associated with avoided GHG emissions (e.g., may have negative carbon intensities).

In some embodiments, at least two of the RNGs provided for the liquefaction process differ from each other in terms of the process that produces the RNG. For example, in some embodiments, at least two RNGs differ from each other in terms of the type of RNG production process (e.g., anerobic digestion or gasification). In some embodiments, at least two of the RNGs provided for the liquefaction process differ from each other in terms of the anaerobic digestion process (e.g., in one process digestate is fed to an open lagoon and in the other process digestate is fed to a closed lagoon). In some embodiments, at least two of the RNGs provided for the liquefaction process differ from each other in terms of the biogas upgrading (e.g., in one process off-gas from biogas upgrading is released to the atmosphere and in the other process off-gas from biogas upgrading is flared (e.g., thermal oxidation)). In some embodiments, at least two of the RNGs provided for the liquefaction process differ from each other in terms of the whether renewable power is used in the process. In some embodiments, at least two of the RNGs provided for the liquefaction process differ from each other in terms of whether co-products are produced during RNG production (e.g., carbon dioxide captured and provided for sequestration). In some instances, it can be advantageous to use RNG for the liquefaction process that is produced in processes that are associated with a relatively low carbon intensity (e.g., using covered lagoons, combusting off-gas from hydrogen purification, using renewable power, providing carbon capture and storage (CCS), etc.).

In some embodiments, at least two of the RNGs differ from each other in terms of their carbon intensity. The term “carbon intensity” or “CI” refers to the quantity of lifecycle GHG emissions associated with a product for a given production process, and is often expressed as grams of CO₂ equivalent emissions per unit of product produced (e.g., gCO₂e/MJ of fuel, gCO₂e/MMBTU of fuel, gCO₂e/kWh of electricity, or kgCO₂e/kg of fuel/product). As will be understood by those skilled in the art, lifecycle GHG emissions and/or carbon intensity are typically determined using Lifecycle Analysis (LCA), which identifies and estimates all GHG emissions in producing a fuel or product, from the growing or extraction of raw materials, to the production of the fuel or product, through to the end use (e.g., well-to-wheel, or well-to-wake emissions). For example, the carbon intensity of RNG can account for carbon emissions associated with feedstock production (e.g., fertilizer use), biogas upgrading (e.g., compression), and/or transport via natural gas pipe system (e.g., methane losses). In addition, the carbon intensity of RNG can account for carbon emission credits, such as those associated with feedstock production (e.g., using a waste feedstock associated with avoided GHG emissions) and/or RNG production (e.g., CCS of carbon-containing material produced from RNG production that is not converted to the RNG). With regard to the latter, one or more carbon-containing material(s) derived from digestate, char, or carbon dioxide (e.g., produced during anaerobic digestion) can be stored as part of a CCS process, thereby reducing the carbon intensity of the RNG.

Those skilled in the art will understand that the carbon intensity of a given product (e.g., fuel) can be dependent upon the methodology used (e.g., as required by the applicable regulatory authority). For example, carbon intensity can be dependent on the system boundaries and/or various methodological assumptions. In general, any methodology can be used to determine carbon intensity. However, when the product is treated for meeting a certain lifecycle GHG reduction threshold under certain regulations (e.g., is treated as a qualifying renewable fuel, a clean fuel, a low carbon intensity fuel, or a biofuel) and/or when the method includes obtaining one or more credits for the product and/or its production, the methodology will be selected to comply with the prevailing rules and regulations in the applicable jurisdiction (e.g., relevant to desired credits). Methodologies for calculating carbon intensities according to various regulatory bodies are well known in the art and can be readily calculated by those of ordinary skill in the art. For example, carbon intensities are often determined using an LCA model, such as the GREET model. The GREET model, which is well-known by those skilled in the art, refers to “The Greenhouse gases, Regulated Emissions, and Energy use in Technologies Model” developed at Argonne National Laboratory (ANL) (e.g., greet.es.anl.gov). Carbon intensities can also be determined based on the product being produced according to a certain pathway (e.g., a fuel pathway). For example, carbon intensities can be pathway certified carbon intensities. In general, the term “fuel pathway” refers to a collective set of processes, operations, parameters, conditions, locations, and technologies throughout all stages that the applicable agency considers appropriate to account for in the system boundary of a complete analysis of that fuel's lifecycle greenhouse gas emissions. In some cases, a fuel pathway can be a specific combination of three components, namely: (1) feedstock, (2) production process, and (3) product or fuel type. Carbon intensities can also be determined using regulatory default value carbon intensities. For example, in the UK, RNG produced from wet manure may have a default carbon intensity of 22 gCO2e/MJ when the digestate is fed to an open enclosure, and when the off-gas from biogas upgrading is not combusted, or may have a default carbon intensity of −100 gCO2e/MJ when the digestate is fed to closed enclosure, and when the off-gas from biogas upgrading is combusted. Carbon intensities can also be determined using disaggregated default values (e.g., associated with certain feedstocks and/or steps in a supply chain) or a mixture of disaggregated default values and measured values (e.g., based on supply chain specific measured values). In some cases, carbon intensities can be calculated (e.g., using an LCA) and then verified by the regulatory agency (e.g., the fuel pathway and/or corresponding carbon intensities can be approved by the regulatory agency) and/or by a verification body approved and/or appointed by the regulatory agency.

In some embodiments, the RNG includes at least two batches of RNG that differ in terms of one or more sustainability characteristics. Sustainability characteristics can include, but are not limited to, the feedstock, country of origin of biomethane, carbon intensity, and/or production process (e.g., see the International Sustainability & Carbon Certification (ISCC)). Sustainability characteristics are well known in the art and can be readily determined by those of ordinary skill in the art (e.g., according to applicable regulations). When one or more sustainability characteristics of the RNGs are being compared and/or used in a same calculation, they are determined using the same methodology and/or applicable regulations. For example, when comparing weighted-average carbon intensities of RNG in the feedstock for liquefaction and the fuel for liquefaction, all of the carbon intensities are determined using the same methodology. In some embodiments, at least two of the RNGs differ from each other in terms of one or more sustainability characteristics recognized by the ISCC. In some embodiments, at least two of the RNGs differ from each other in terms of the country in which they originated.

In some embodiments, the RNG provided for the liquefaction process includes one or more consignments of RNG, where at least one consignment is an aggregate of other consignments. In such aggregates, RNG from multiple sources and/or feedstocks is treated as a single consignment. In some cases, the constituent RNGs of the aggregate consignment may have the same declared sustainability characteristic (e.g., be produced from the same type of feedstock) or be produced from a same source (e.g., a digester processing manure and straw). In some embodiments, the carbon intensity of the aggregate consignment is a regulatory default value carbon intensity. In some embodiments, where two or more of the constituent RNGs have different carbon intensities, the carbon intensity of the aggregate consignment corresponds to the carbon intensity of the constituent RNG having the highest carbon intensity.

In some embodiments, the RNG provided for the liquefaction includes at least two batches of RNG (e.g., at least two consignments of RNG). In such embodiments, the RNG provided can have a weighted-average carbon intensity. The weighted-average carbon intensity of RNG made up of multiple RNGs can be calculated as follows:

$$\frac{{CI}_{B 1} \times {MJ}_{B 1} + {CI}_{B 2} \times {MJ}_{B 2} + … + {CI}_{B n} \times {MJ}_{n}}{{MJ}_{B 1} + {MJ}_{B 2} + … + {MJ}_{n}} \qquad ( 1 )$$

where CI_{B1} refers to the carbon intensity of a first RNG, MJ_{B1} refers to an amount of the first RNG (in MJ), CI_{B2} refers to the carbon intensity of a second RNG, MJ_{B2} refers to an amount of the second RNG (in MJ), CI_{Bn} refers to the carbon intensity of the nth RNG (if more than 2 RNG are provided), and MJ_{Bn} refers to an amount of the nth RNG (in MJ) (if more than 2 biomethanes are provided). In instances where there is only one RNG present, the weighted average carbon intensity of the RNG is the carbon intensity of the RNG that is present.

### Producing Bio-LNG

The term “bio-LNG”, as used herein, refers to liquefied renewable natural gas. In general, the bio-LNG is produced from a methane-containing feed that contains RNG (e.g., one or more consignments of RNG). In some embodiments of the instant disclosure, the methane-containing feed provided for the liquefaction also contains fossil natural gas. In general, the methane-containing feed is withdrawn from one or more natural gas pipe systems. For example, fossil natural gas can be withdrawn from one natural gas pipe system, while RNG is withdrawn from another natural gas pipe system. Each natural gas pipe system can be part of and/or connected to a natural gas grid, or can be configured to provide natural gas and/or RNG from one or more containers (e.g., a CNG tank). In some embodiments, the fossil natural gas and RNG are withdrawn from a same natural pipe system, and thus have substantially the same chemical composition. At least a portion of the methane-containing feed is feedstock for the liquefaction. The term “feedstock for liquefaction” refers to the portion of the gas feed that contributes atoms to the liquefied product (e.g., LNG and/or bio-LNG).

The portion of the methane-containing feed that is feedstock for the liquefaction can be liquefied using any suitable technology or combination of technologies. For example, processes and/or facilities for producing bio-LNG and/or fossil-LNG often include precleaning units/unit operations and liquefaction units/unit operations.

Precleaning removes impurities from the methane-containing feed (e.g., the feedstock), which may solidify or otherwise cause complications during the liquefaction. For example, precleaning often removes water (e.g., using molecular sieves) and/or acid gases (e.g., carbon dioxide and/or hydrogen sulfide, using an amine system). Depending on the composition of the methane-containing feed, precleaning may also remove mercury, mercaptan, and/or natural gas liquids (NGL). Precleaning can be conducted prior to liquefaction and/or as part of the liquefaction (e.g., at least some of the precleaning can overlap with the precooling in liquefaction and/or between different liquefaction stages).

Liquefaction is often conducted by compressing at least some of the methane-containing feed to elevated pressure, and passing it through multiple cooling stages so that it is cooled to successively lower temperatures until liquefaction. Cooling can be achieved, at least in part, by heat exchange with one or more refrigerants such as propane, propylene, ethane, ethylene, methane, nitrogen, etc. (e.g., mixed refrigerant systems).

As will be appreciated by those skilled in the art, there are various technologies used for liquefying natural gas that may be suitable for use in method(s) and/or system(s) disclosed herein. Liquefaction technologies often provide a precooling circuit (e.g., containing a number of consecutive heat exchangers) to cool the natural gas feed prior to liquefaction via the main cryogenic heat exchanger. Some examples of known liquefaction technologies that may be used include the propane-precooled mixed refrigerant (C3/MR) cycle, dual mixed refrigerant (DMR) cycle, cascade cycle, single mixed refrigerant (SMR) cycle, and/or the nitrogen expander cycle. In the C3/MR process, the refrigerant used for the pre-cooling heat exchanger is mainly propane and the refrigerant used for the main cryogenic heat exchanger is a mixed refrigerant. In the DMR process, typically, the refrigerant used for the pre-cooling heat exchanger is a first mixed refrigerant and the refrigerant used for the main cryogenic heat exchanger is a second mixed refrigerant.

As will be appreciated by those skilled in the art, depending on the technology, there can be one or more refrigerant circuits. Often, the final refrigerant cycle is a methane refrigeration cycle (i.e., a refrigeration cycle employing a predominately methane refrigerant), which can be an open-loop methane refrigeration cycle, or a closed-loop methane refrigeration cycle. In a closed-loop methane refrigeration cycle, the predominately methane refrigerant is not derived from or combined with the natural gas stream being liquefied. Depending on the technology, each refrigerant circuit can include a refrigerant compressor, one or more intercoolers, a refrigerant precooler, a refrigerant separator, one or more heat exchangers, and one or more Joule-Thomson (JT) valves and/or expanders.

In general, most liquefaction technologies can be energy intensive (e.g., require significant electrical energy), with a large portion of the energy being required for compressors. For example, compressors are often used for compressing the methane-containing feed (e.g., prior to cooling) and the refrigerant fluids. The compressors (e.g., compressor trains) used to process the refrigerant fluids used in the heat exchangers are particularly energy intensive. Conventionally, refrigerant compressors are driven by gas turbine engines, steam turbines, or electric motors and typically require large quantities of power.

In some embodiments, a portion of the methane-containing feed is used as fuel used to generate heat and/or power (e.g., motive power) used in the liquefaction process (e.g., for the cooling). For example, in some embodiments, at least some of the power required for the compressor(s) (e.g., refrigerant compressors) is generated by combusting the portion of the methane-containing feed diverted for use as fuel (e.g., to generate heat and/or power). In general, this portion of the methane-containing feed can be combusted using any suitable equipment that can produce heat and/or power (e.g., motive power). For example, some examples of suitable systems may include steam turbines or gas turbine engines configured to drive one or more compressors directly (e.g., direct fueled compressors), or steam turbines or gas turbine engines that generate electricity that is used to drive one or more compressors (e.g., a combined heat and power unit (CHP)).

The term “methane-containing feed”, as used herein, refers to feed provided for the liquefaction process (i.e., feed that is liquefied and/or is used to produce heat and/or power for use within the liquefaction process).

In some embodiments, the methane-containing feed provided for the liquefaction process is split into a first portion that is feedstock for liquefaction and a second portion that is fuel used to produce heat and/or power for the process (e.g., for the liquefaction). When the methane-containing feed provided for the process is split into a first portion that is feedstock for the liquefaction and a second portion that is fuel used to generate heat and/or power, the split refers to the distribution based on energy and does not imply that each portion has the same chemical composition.

In some embodiments, the methane-containing feed provided for the liquefaction process is split between a first portion that contains about 80% to about 95% of the total gas provided (calculated by energy), which is directed to an inlet of a liquefaction system, and a second portion that contains about 5% to about 20% of the total gas provided (calculated by energy), which is directed to an inlet of a system (e.g., generator) that produces heat and/or power.

In some embodiments, the methane-containing feed provided for the liquefaction process is split between first and second portions that have the same chemical composition. In some embodiments, the methane-containing feed provided for the liquefaction process is split between first and second portions that have different chemical compositions. For example, in some embodiments, the precleaning of the methane-containing feed produces a tail gas, and/or liquids (e.g., natural gas liquids), that are used as fuel to produce heat and/or power for the process. In this embodiment, the portion of the methane-containing feed that is fuel for producing heat and/or power can contain only the tail gas and/or liquids, or can contain the tail gas and/or liquids in combination with another gas. For example, any stream produced from the process (e.g., by-product or tail gas) that includes part of the RNG not converted to bio-LNG can be combusted to produce heat and/or power for the liquefaction process.

In some embodiments, the portion of the methane-containing feed that is fuel used to produce heat and/or power for the liquefaction process includes: tail gas, one or more liquids produced from the precleaning, a portion of the methane-containing feed that has been precleaned, a portion of the methane-containing feed that has not been precleaned, or any combination thereof.

In some embodiments, the portion of the methane-containing feed that is fuel used to produce heat and/or power for the liquefaction process includes RNG (e.g., at least part of one or more batches of RNG). Depending on the amount and/or distribution (e.g., allocation) of the RNG, the liquefied gas produced from the process can include bio-LNG and/or fossil-LNG. As the bio-LNG and fossil-LNG may not be produced as discrete volumes (e.g., the RNG and fossil natural gas may be provided simultaneously and/or using mass or energy balance), the liquefied gas produced can be split into notional bio-LNG and fossil-LNG portions (e.g., based on the renewable fraction of the methane-containing feed that is feedstock for liquefaction).

Those skilled in the art having the benefit of the teachings herein will appreciate that when the methane-containing feed is split into the first and second portions and/or when the RNG is distributed (e.g., allocated) to the first and/or second portions, the corresponding values can be determined at any time during the process (e.g., after the bio-LNG is produced, using mass or energy balance).

In general, at least the bio-LNG will be transported, regasified, used as a fuel, and/or used in a process for producing product (e.g., fuel). For example, the bio-LNG and/or fossil-LNG, which can be transported together or separately, can be transported via sea (e.g., in double-hulled LNG ships), road (e.g., in LNG truck tankers), and/or rail (e.g., specially designed tank wagons).

### Producing Vaporized RNG

In some embodiments, liquefied feed including bio-LNG and/or fossil-LNG is provided for producing vaporized RNG and/or vaporized natural gas. For example, once the liquefied gas (e.g., bio-LNG and/or fossil-LNG) is produced and transported and/or is stored, it is often vaporized prior to use and/or injection into a natural gas pipe system (i.e., is regasified). This regasification process can be conducted at any suitable location. For example, when liquefied feed is transported by ship, the regasification system can be installed on the ship, on a jetty, on a floating storage and regasification unit (FSRU), or at a land-based facility (e.g., land-based terminal). With regard to the latter, the liquefied feed can be transferred from the ship to land via cryogenic pipelines, wherein it is regasified or further transported by road and then regasified.

In general, any suitable regasification process can be used to produce the vaporized RNG and/or vaporized natural gas. Regasification processes often include heat exchange to warm the liquefied gas and/or decompression. The heat exchanger(s) can use any suitable heat exchange arrangement, which may include but is not limited to, one or more shell and tube exchangers, plate heat exchangers, plate and shell heat exchangers, adiabatic wheel heat exchangers, plate fin heat exchangers, pillow plate heat exchangers, fluid heat exchangers, waste heat recovery units, phase-change heat exchangers, direct contact heat exchangers, helical-coil heat exchangers, spiral heat exchangers, cold box heat exchangers, etc. In some embodiments, the liquefied gas is warmed by heat exchange via an intermediate fluid (e.g., such as sea water, glycol, glycol/water mixture, methanol, propanol, propane, butane, etc.). Depending on the system, the intermediate fluid can be heated by ambient air, or can be heated by combusting a portion of the liquefied gas (e.g., boil-off). Alternatively, air vaporizers can be used where several large fans push air through heat exchangers to vaporize the liquefied gas. When the vaporized gas is injected into a natural gas pipe system, or otherwise is used at elevated pressures, the regasification process can include re-pressurizing the liquefied gas to the required pressure (e.g., local pipeline pressure) using cryogenic pumps prior to it being vaporized. In general, regasification processes can be energy intensive.

In some embodiments, the liquefaction process and regasification process are conducted at the same facility (e.g., peak-shaving facility), and at least some of the heat and/or power used for the regasification is generated from the combustion of the fuel portion of the methane-containing feed provided for liquefaction.

In some embodiments, the liquefaction process and regasification process are conducted at different facilities, and at least some of the power used for the regasification is generated from the combustion of the fuel portion of the methane-containing gas provided for liquefaction (e.g., provided via an electrical grid).

In some embodiments (e.g., where the liquefaction and regasification processes are conducted at different facilities), the liquefied feed to be vaporized is split into a first portion that is feedstock for regasification (e.g., liquefied gas that is vaporized), and a second portion that is fuel used to generate heat and/or power for the regasification process. When the liquefied feed provided for the process is split into a first portion that is feedstock for the regasification and a second portion that is fuel used to generate heat and/or power, the split refers to the distribution based on energy and does not imply that each portion has the same chemical composition and/or is in the same state. With regard to the latter, the second portion that is fuel used to generate heat and/or power can be in gaseous form for the combustion (e.g., can be boil-off or can be part of the vaporized gas).

In general, the liquefied feed to be vaporized will include at least the transported bio-LNG. In some embodiments, the liquefied feed to be vaporized also includes transported fossil-LNG. In some embodiments, the regasification facility also regasifies fossil-LNG from other process(es). In embodiments where the liquefied feed to be vaporized includes only the transported bio-LNG, or includes the transported bio-LNG and the transported fossil-LNG, the second portion that is fuel used to generate heat and/or power for the process (e.g., regasification) can be combusted with other feeds (e.g., natural gas withdrawn from a natural gas pipe system).

In general, the regasification process produces vaporized RNG and/or vaporized fossil natural gas. The terms “vaporized renewable natural gas” (or “vaporized RNG”) and “vaporized fossil natural gas” refer to RNG and natural gas, respectively, that was once liquid. In some embodiments, the vaporized RNG and/or vaporized fossil natural gas is injected into a natural gas pipe system (e.g., the same pipe system from which the methane-containing feed for liquefaction was withdrawn, or a different natural gas pipe system). In some embodiments, the vaporized RNG and/or vaporized fossil natural gas is used to produce product (e.g., fuel, such as transportation fuel and/or biofuel, or chemical product). In some embodiments, the product is produced from RNG derived from the bio-LNG. The term “RNG derived from the bio-LNG”, refers to RNG that is obtained from the bio-LNG directly (e.g., is produced by vaporizing the bio-LNG) or indirectly (e.g., is produced by vaporizing the bio-LNG, and transporting the vaporized RNG as a fungible batch in a natural gas pipe system).

### Disproportionate Distribution

In some embodiments, an increase in the quantity of bio-LNG produced and/or decrease in the carbon intensity of the bio-LNG produced (or product produced using the bio-LNG) is achieved by distributing the RNG (e.g., at least one consignment of RNG) disproportionately between: (a) feedstock for liquefaction, and (b) fuel for producing heat and/or power used for the liquefaction process.

For purposes herein, a proportionate distribution of RNG between (a) the feedstock for liquefaction and (b) fuel for producing heat and/or power means that the RNG is distributed (e.g., allocated) such that the energy fraction of each of the RNGs is the same in: (a) the feedstock for liquefaction and (b) the fuel for producing heat and/or power.

For purposes herein, a disproportionate distribution of RNG between (a) the feedstock for liquefaction and (b) fuel for producing heat and/or power means that the RNG is distributed (e.g., allocated) such that the energy fraction of at least one RNG is different between (a) the feedstock for liquefaction and (b) the fuel for producing heat and/or power.

The term “energy fraction”, as used herein with reference to a given RNG in a fluid (e.g., the methane-containing feed provided for the liquefaction process, the feedstock for liquefaction, or the fuel for producing heat and/or power), refers to the energy of the given RNG in the fluid in MJ divided by the energy in MJ of the entire fluid (e.g., sum of the energy of all of the RNG and fossil natural gas within the fluid). The energy (in MJ) will be calculated for a given time period (e.g., hour, month, 3 months, etc.) and/or for a given batch. The term “batch”, as used herein, refers to a certain quantity of fluid (e.g., measured using volume, mass, and/or energy delivered) and does not imply or exclude an interruption in the production and/or delivery. For purposes herein, an energy fraction can be 0, 1, or any value therebetween, and/or can be expressed as a percentage.

The terms “distribute” or “distributed” or “distributing”, as used herein in respect of a particular element (e.g., at least part of the RNG or bio-LNG), refers to physically distributing the element and/or to allocating the element. The terms “allocate”, “allocated”, or “allocating”, as used herein in respect of a particular element, refers to the designation of the element by way of documentation and/or calculation. For example, a portion of the RNG can be allocated as feedstock by recording the portion of the RNG as being used as feedstock in a GHG emissions evaluation and/or for one or more mass or energy balance calculations. Those skilled in the art having the benefit of the teachings herein will appreciate that the allocation of an element (e.g., a portion of the RNG) can be conducted on paper and/or electronically, and/or can be conducted prior to and/or after its use.

As an example, consider a liquefaction process wherein a methane-containing feed made up of 25% a given RNG and 75% fossil natural gas, on an energy basis, is provided for the liquefaction process. If this feed is split such that 90% of the feed is feedstock for liquefaction and 10% is fuel for producing heat and/or power for the liquefaction process, on an energy basis, and if none of the RNG is specifically allocated, then a proportionate distribution results such that the energy fraction of the given RNG in each of the feedstock and the fuel is 25%. If, however, the RNG is allocated entirely as feedstock (i.e., with no RNG being fuel) then a disproportionate distribution results wherein the energy fraction of the given RNG in the feedstock is about 28% and the energy fraction of the given RNG in the fuel is 0%.

Those skilled in the art having the benefit of the teachings herein will appreciate that the disproportionate distribution can be determined for a given batch of product (e.g., bio-LNG) produced or for a given slice of time (e.g., minutes, hours, days), for the purpose of determining lifecycle GHG emissions and/or yield of product from the RNG. For example, in some embodiments, if a given quantity of a given RNG is provided for bio-LNG production, the RNG can be distributed preferentially as feedstock to increase the yield of bio-LNG. In some embodiments, the RNG can be distributed preferentially as fuel to reduce the carbon intensity of the bio-LNG. In some embodiments, the disproportionate allocation occurs in a slice of time (e.g., minutes, hours, days) rather than averaged over a longer period of time (e.g., year).

In general, the disproportionate distribution can be selected to: (i) increase the amount of bio-LNG produced and/or increase the amount of product derived from the RNG and/or bio-LNG that is treated as renewable (e.g., to maximize the renewable production), (ii) decrease the carbon intensity of the bio-LNG and/or decrease the carbon intensity of product produced using the bio-LNG (e.g., to maximize the GHG reduction), or (iii) some combination of (i) and (ii) (e.g., decrease carbon intensity and maximize renewable production, or some compromise). The increase in amounts produced and/or the decrease in carbon intensity is relative to that achieved when the RNG is distributed proportionately between (a) feedstock for liquefaction, and (b) fuel for producing heat and/or power used for the process. Those skilled in the art having the benefit of the teachings herein will appreciate that the disproportionate distribution can be selected based on the specifics of the case.

For example, if the bio-LNG, when distributed proportionately, has a carbon intensity that makes it, or product produced using it, eligible for one or more desired credits, then it may be advantageous to select the disproportionate distribution to increase the amount of bio-LNG produced rather than to decrease the carbon intensity of the bio-LNG. In some cases, this can increase the amount of bio-LNG produced by 5-15%. Alternatively, if the bio-LNG has a carbon intensity that makes it, or product produced using it, ineligible for one or more desired credits, or limits the value or number of credits for which it is eligible, then it can be advantageous to select the disproportionate distribution to decrease the carbon intensity of the bio-LNG rather than to increase the amount of bio-LNG produced.

With regard to decreasing the carbon intensity of the bio-LNG, or product produced using the bio-LNG (e.g., the renewable content of fuel), consider the following. Although the bio-LNG and fossil-LNG are produced using the same liquefaction equipment, since they are produced from different feedstocks, they typically will have different carbon intensities. However, despite the fact that the bio-LNG is derived from a renewable feedstock, it is possible that the lifecycle GHG emissions associated with the bio-LNG or product produced using the bio-LNG, can be too high to qualify for one or more desired credits. For example, in some cases, the bio-LNG, or product produced using the bio-LNG, may need to meet a certain lifecycle GHG reduction in order to be eligible for one or more credits and/or as qualifying renewable fuel.

The term “qualifying renewable fuel”, as used herein, refers to fuel that qualifies as renewable fuel, low carbon intensity fuel, and/or biofuel under applicable environmental regulations. For example, one example of qualifying renewable fuel is fuel that is eligible to generate RINs under the RFS program. Another example of qualifying renewable fuel is fuel (e.g., development fuel) that is eligible for certificates awarded under the Renewable Transport Fuel Obligation (RTFO) (e.g., RTFC). Yet another example of qualifying renewable fuel is fuel that is eligible for certificates awarded under compliance with RED II. In general, qualifying renewable fuels can be associated with meeting a certain GHG emissions reduction and/or having a carbon intensity below a certain threshold. For example, an at least a 20% GHG emissions reduction relative to conventional fuels is typically required to qualify as a conventional renewable fuel under the RFS program. Under RED II, transport biofuels typically have to achieve GHG emissions reduction of 65%.

If the GHG emissions associated with the liquefaction process and/or regasification process make the bio-LNG and/or product produced using the bio-LNG ineligible to be qualifying renewable fuel (even if derived from biomass), then distributing the RNG disproportionately between feedstock and fuel for liquefaction in order to bring the carbon intensity below the threshold can improve the process and/or increase the practical applications of bio-LNG. Alternatively, distributing the RNG disproportionately between feedstock and fuel for liquefaction in order to maximize the GHG emission reduction and maximize the value or number of credits obtainable can improve the production process and/or increase the practical applications of bio-LNG.

In some embodiments, the RNG is distributed disproportionately between (a) feedstock for liquefaction, and (b) fuel for producing heat and/or power used for the liquefaction process, in order to reduce the carbon intensity of the bio-LNG produced (or reduce a carbon intensity of product produced using the bio-LNG). For example, distributing the RNG disproportionately such that more RNG (calculated by energy) is distributed for use as fuel for producing heat and/or power than would be provided with a proportionate distribution, can reduce the carbon intensity of the bio-LNG and/or product produced using the bio-LNG (relative to a proportionate distribution). Alternatively, if the RNG includes RNG from more than one biogas source, distributing the RNG disproportionately such that the RNG provided for use as fuel for producing heat and/or power has a carbon intensity (e.g., a lower weighted-average carbon intensity) than would be achieved with a proportionate distribution can reduce the carbon intensity (e.g., of the bio-LNG and/or product produced using the bio-LNG). The weighted-average carbon intensity of RNG provided for fuel can be calculated using Eq. 1, wherein MJ_{B1}, MJ_{B2}, . . . MJ_{Bn} refers to the amount of the first RNG, second RNG, . . . nth RNG in the fuel (in MJ).

In some embodiments, the RNG is distributed disproportionately between (a) feedstock for liquefaction, and (b) fuel for producing heat and/or power used for the production process, in order to increase the amount of bio-LNG produced. For example, distributing the RNG disproportionately such that more RNG (calculated by energy) is distributed for use as feedstock for liquefaction than would be provided with a proportionate distribution, can increase the amount of bio-LNG produced (i.e., from a given amount of RNG relative to a proportionate distribution).

In some embodiments, the RNG is distributed disproportionately between (a) feedstock for liquefaction, and (b) fuel for producing heat and/or power used for the production process, in order to increase a quantity of product at least partially derived from the RNG that is treated as renewable under applicable regulations (i.e., from a given amount of RNG) relative to a proportionate distribution. For example, distributing the RNG disproportionately such that more RNG (calculated by energy) is distributed for use as feedstock for liquefaction than would be provided with a proportionate distribution, can increase the amount of bio-LNG produced and thus used to produce the product.

In some embodiments, the RNG is distributed disproportionately between (a) feedstock for liquefaction, and (b) fuel for producing heat and/or power used for the production process, in order to increase a renewable content of product produced using the bio-LNG. When product is produced from the co-processing of renewable and non-renewable feedstocks, the product can have renewable content. The term “renewable content”, as used herein, refers the portion of the product (e.g., fuel) that is treated as renewable (e.g., a biofuel) under applicable regulations. The quantification of the renewable content can be determined using any suitable method and is typically dependent upon the applicable regulations.

In some embodiments, the RNG is distributed disproportionately between (a) feedstock for liquefaction, and (b) fuel for producing heat and/or power used for the production process, in order to reduce the carbon intensity of the bio-LNG produced (or reduce a carbon intensity of product produced using the bio-LNG) and in order to increase the amount of bio-LNG produced (or increase a quantity of product at least partially derived from the RNG that is treated as renewable under applicable regulations or increase a renewable content of product produced using the bio-LNG). For example, in some embodiments, multiple consignments of RNG are provided having different carbon intensities. In some cases, the amount of bio-LNG produced can be maximized, while still meeting a target carbon intensity, by distributing the RNG consignment having the lowest carbon intensity for use as fuel for producing heat and/or power in an amount sufficient to meet the target carbon intensity and distributing the remaining amount of RNG as feedstock for liquefaction.

Advantageously, in producing a larger quantity of bio-LNG and/or bio-LNG having a lower carbon intensity, the bio-LNG (or fuel or produced using the bio-LNG) can be eligible for more and/or higher value credits, thereby further improving economics. In some embodiments, the disproportionate distribution increases a quantity of credits (e.g., fuel credits) for which the bio-LNG, product produced using the bio-LNG, or production process, any combination thereof, is eligible.

In some embodiments, the RNG is distributed disproportionately between (a) feedstock for liquefaction, and (b) fuel for producing heat and/or power used for the process, such that the feedstock and fuel have different renewable fractions. In some embodiments, the RNG is distributed disproportionately between (a) feedstock for liquefaction, and (b) fuel for producing heat and/or power used for the process, such that the feedstock has a larger renewable fraction than the fuel. In some embodiments, the RNG is distributed disproportionately between (a) feedstock for liquefaction, and (b) fuel for producing heat and/or power used for the process, such that the feedstock and fuel have different renewable fractions, and such that the RNG in the feedstock and in the fuel have a same carbon intensity (e.g., same weighted average carbon intensity). The term “renewable fraction”, as used herein, refers to the fraction of a fluid (e.g., methane-containing feed provided for the liquefaction process, feedstock for liquefication, or fuel for producing heat and/or power) that is treated as renewable (e.g., treated as RNG or bio-LNG) under applicable regulations. The renewable fraction, which can be expressed as a percentage and is calculated based on energy, can be 0, 1, or any value therebetween.

In some embodiments, the carbon intensity of the bio-LNG, product produced using the bio-LNG, or a combination thereof is sufficiently low enough for the bio-LNG, product, or combination thereof to be treated as qualifying renewable fuel when the RNG is distributed proportionately between (a) feedstock for liquefaction and (b) fuel for producing heat and/or power, and the disproportionate distribution provides the feedstock for liquefaction with a higher renewable fraction than the fuel for producing heat and/or power. Advantageously, this embodiment can increase the amount of qualifying renewable fuel produced from a given quantity of RNG (i.e., increase the yield of qualifying renewable fuel).

In some embodiments, the carbon intensity of the bio-LNG, product produced using the bio-LNG, or a combination thereof is too high for the bio-LNG, product, or combination thereof to be treated as qualifying renewable fuel when the RNG is distributed proportionately between (a) feedstock for liquefaction and (b) fuel for producing heat and/or power, and the disproportionate distribution provides the fuel for producing heat and/or power with a higher renewable fraction than the feedstock for liquefaction. In some cases, this can increase the amount of qualifying renewable fuel produced from zero to a significant amount (although it will typically reduce the amount of bio-LNG produced). This embodiment can be particularly useful when the bio-LNG is used to produce product (e.g., transportation fuel) as it may reduce the carbon intensity of the bio-LNG to an extent that it may make the product (e.g., renewable content of the transportation fuel) eligible to be treated as qualifying renewable fuel, or at least eligible for one or more credits.

In some embodiments, the carbon intensity of the bio-LNG, the product produced using the bio-LNG, or a combination thereof is too high for the bio-LNG, product produced using the bio-LNG, or combination thereof to be treated as a qualifying renewable fuel when the RNG is distributed proportionately between (a) feedstock for liquefaction and (b) fuel for producing heat and/or power, and the disproportionate distribution provides the fuel for producing heat and/or power with a lower weighted-average carbon intensity than the feedstock for liquefaction. In some cases, this can increase the amount of qualifying renewable fuel produced from zero to a significant amount (although it will typically reduce the amount of bio-LNG produced). As bio-LNG produced from many types of feedstocks/processes may have a carbon intensity that makes it eligible to be treated as qualifying renewable fuel, this embodiment can be particularly useful when the bio-LNG is used to produce product (e.g., transportation fuel) as it may reduce the carbon intensity of the bio-LNG to an extent that it may make the product (e.g., renewable content of the transportation fuel) eligible to be treated as qualifying renewable fuel, or at least eligible for one or more credits.

A disproportionate distribution can be particularly advantageous when at least one batch of the RNG has a carbon intensity that is greater than about 10 gCO₂/MJ, about 20 gCO₂e/MJ, about 30 gCO₂e/MJ, or about 40 gCO₂e/MJ, as calculated using GREET 2022, and when the bio-LNG is used to produce product (e.g., a fuel other than RNG). In some embodiments, the RNG has a weighted-average carbon intensity between about 5 gCO₂e/MJ and about 60 gCO₂e/MJ, between about 10 gCO₂e/MJ and about 50 gCO₂e/MJ, or between about 20 gCO₂e/MJ and about 45 gCO₂e/MJ, as calculated using GREET 2022. In some embodiments, the RNG has a weighted-average carbon intensity of at least about 10 gCO₂e/MJ, at least 15 gCO₂e/MJ, at least about 20 gCO₂e/MJ, or at least about 25 gCO₂e/MJ, as calculated using GREET 2022. In some embodiments, the RNG contains one or more batches of landfill gas.

In some embodiments, the RNG includes at least two batches of RNGs having different carbon intensities, and the disproportionate distribution allocates the batch of RNG having the highest carbon intensity to the feedstock for liquefaction and the batch of RNG having the lowest carbon intensity to fuel for producing heat and/or power.

In some embodiments, the RNG is distributed disproportionately between (a) feedstock for liquefaction, and (b) fuel for producing heat and/or power used for the production process such that the feedstock has at least one characteristic that is distinct from that of the fuel, wherein the at least one characteristic is renewable fraction and/or carbon intensity (e.g., weighted average carbon intensity) of the RNG.

### ALTERNATIVE, OR ADDITIONAL, DISPROPORTIONATE DISTRIBUTION

In some of the above-described embodiments, the RNG is distributed (e.g., allocated) disproportionately between: (a) feedstock for liquefaction, and (b) fuel for producing heat and/or power used for the liquefaction process. However, in general, it can be advantageous to distribute (e.g., allocate) the RNG, bio-LNG produced from the RNG, and/or vaporized RNG produced from the bio-LNG, disproportionately between (a) feedstock and (b) fuel for various parts of the bio-LNG supply chain (i.e., any time between when the RNG is provided for the liquefaction process to when the bio-LNG or vaporized RNG produced from the bio-LNG is provided to the end user who receives RNG associated with the environmental attributes of the RNG provided for liquefaction). For example, some points in the supply chain where a portion of the RNG, bio-LNG produced from the RNG, and/or vaporized RNG can be combusted to produce heat and/or power include the liquefaction process (as discussed above), the regasification process, and/or the transport of the bio-LNG. For example, with regard to the latter, in LNG carriers a portion of the LNG (e.g., boil-off) can be used in the ships' boilers.

In some embodiments, an increase in the quantity of vaporized RNG and/or the carbon intensity of the vaporized RNG (or product produced using the vaporized RNG) is reduced by distributing the bio-LNG disproportionately between: (a) feedstock for regasification, and (b) fuel for producing heat and/or power used for the regasification. The term “feedstock for regasification”, as used herein, refers to the portion of the liquid feed that contributes atoms to the regasified product.

A proportionate distribution of bio-LNG between (a) feedstock for regasification and (b) fuel for producing heat and/or power means that the bio-LNG is distributed (e.g., allocated) such that the energy fraction of each bio-LNG is the same in: (a) the feedstock for regasification and of (b) the fuel for producing heat and/or power.

A disproportionate distribution of bio-LNG between (a) feedstock for regasification and (b) fuel for producing heat and/or power means that the bio-LNG is distributed (e.g., allocated) such that the energy fraction of at least one bio-LNG is different between (a) the feedstock for regasification and of (b) the fuel for producing heat and/or power.

In general, the disproportionate distribution can be selected to: (i) increase the amount of vaporized RNG produced and/or increase the amount of product produced using the vaporized RNG that is treated as renewable (e.g., to maximize the renewable production), (ii) decrease the carbon intensity of the vaporized RNG and/or decrease the carbon intensity of product produced using the vaporized RNG (e.g., to maximize the GHG reduction), or (iii) some combination of (i) and (ii) (e.g., decrease carbon intensity and maximize renewable production, or some compromise). The increase in amounts produced and/or the decrease in carbon intensity is relative to that achieved when the bio-LNG is distributed proportionately between (a) feedstock for regasification, and (b) fuel for producing heat and/or power. Those skilled in the art having the benefit of the teachings herein will appreciate that the disproportionate distribution can be selected based on the specifics of the case.

In some embodiments, the bio-LNG is distributed disproportionately between (a) feedstock for regasification, and (b) fuel for producing heat and/or power used for the regasification process, in order to reduce the carbon intensity of the vaporized RNG produced (or reduce a carbon intensity of product produced using the vaporized RNG). For example, in some embodiments, the bio-LNG is distributed disproportionately such that more bio-LNG (calculated by energy) is distributed for use as fuel for producing heat and/or power for the regasification than would be provided with a proportionate distribution. In some embodiments, the bio-LNG is distributed disproportionately such that the bio-LNG provided for use as fuel for producing heat and/or power for the regasification has a lower weighted-average carbon intensity than would be achieved with a proportionate distribution. In these embodiments, the fuel can include transported fossil-LNG and/or pipeline fossil natural gas.

In some embodiments, the bio-LNG is distributed disproportionately between (a) feedstock for regasification, and (b) fuel for producing heat and/or power used for the regasification process, in order to increase the amount of vaporized RNG produced. For example, in some embodiments, the bio-LNG is distributed disproportionately such that more bio-LNG (calculated by energy) is distributed for use as feedstock for regasification than would be provided with a proportionate distribution.

In some embodiments, the bio-LNG is distributed disproportionately between (a) feedstock for regasification, and (b) fuel for producing heat and/or power used for the production process, in order to increase a quantity of product (e.g., renewable content of fuel) that is treated as qualifying renewable fuel under applicable regulations (i.e., from a given amount of bio-LNG relative to a proportionate distribution).

In some embodiments, the RNG is distributed disproportionately between (a) feedstock for liquefaction, and (b) fuel for producing heat and/or power used for the liquefaction process, and bio-LNG is distributed disproportionately between (a) feedstock for regasification, and (b) fuel for producing heat and/or power used for the regasification process. Advantageously, this combination may provide the lifecycle GHG reductions required for producing qualifying renewable fuel and/or obtaining high value credits, particularly when the bio-LNG is part of the supply chain for producing product that otherwise may not qualify as qualifying renewable fuel and/or may not qualify for high value credits.

In some embodiments, an increase in the quantity of bio-LNG or vaporized RNG is achieved by distributing the RNG, bio-LNG produced from the RNG, and/or vaporized RNG produced from the bio-LNG, disproportionately between: (a) the supply chain portion of the corresponding fluid, and (b) the fuel portion of the corresponding fluid. The term “supply chain portion”, as used herein, refers to the portion of the corresponding fluid that is deemed to move to the next step of the supply chain and thus can facilitate the transfer of at least some of the environmental attributes associated with the initial RNG injected into the natural gas pipe system to the end product (e.g., the bio-LNG or revaporized RNG). The term “fuel portion”, as used herein, refers to the portion of the corresponding fluid that is used to produce heat and/or power for one or more steps in the supply chain (i.e., after the RNG is produced and before the bio-LNG or vaporized RNG is provided).

A disproportionate distribution of RNG, bio-LNG produced from the RNG, and/or vaporized RNG produced from the bio-LNG, between: (a) the supply chain portion of the corresponding fluid, and (b) the fuel portion of the corresponding fluid, means that the RNG, bio-LNG produced from the RNG, and/or vaporized RNG produced from the bio-LNG, respectively, is distributed (e.g., allocated) such that the energy fraction of at least one RNG is different between (a) the supply chain portion of the corresponding fluid, and (b) the fuel portion of the corresponding fluid.

In some embodiments, the bio-LNG produced from the RNG is transported using a vehicle powered by LNG and/or bio-LNG, and the bio-LNG is distributed disproportionately between (a) a portion of the liquefied gas that is transported and makes it to the destination, and (b) a portion of the liquefied gas that is combusted during transport.

### Uses of the Bio-LNG

In some embodiments, at least some of the bio-LNG is provided for use as a fuel. For example, bio-LNG can be used in existing LNG-fueled engines and can be transported, and stored and bunkered in ports using existing LNG infrastructure. In some embodiments, the bio-LNG is provided for use as marine fuel (e.g., to fuel container ships or cruise ships). For example, bio-LNG can be used instead of conventional marine fuels such as heavy fuel oil (HFO) and marine gas oil (MGO). In some embodiments, the bio-LNG is provided for fueling heavy duty vehicles (e.g., refuse haulers, grocery delivery trucks, transit buses, and/or coal miner lifters). In some embodiments, the bio-LNG is provided for use as jet engine fuel, where its low temperature can also be used for cooling.

In some embodiments, at least some of the bio-LNG is used to produce product (e.g., one or more products such as fuel and/or chemical products). The term “used to produce product”, with reference to a material such as RNG or bio-LNG, refers to using the material directly or indirectly, unless otherwise specified. The term “indirectly”, as used herein with reference to using RNG or bio-LNG to produce a product, implies one or more intervening steps prior to the production of the product. Such intervening steps can include the production of one or more intermediates (e.g., fuel precursors and/or feedstock for subsequent processes) using the bio-LNG, or RNG derived from the bio-LNG, and/or can include regasifying the bio-LNG and/or transporting vaporized RNG produced by regasifying the bio-LNG as a fungible batch in a natural gas pipe system.

In general, when bio-LNG is used to produce product, the bio-LNG, or RNG derived from the bio-LNG, can be used as feedstock and/or as fuel (e.g., to produce heat and/or power for one or more processes). In some embodiments, the bio-LNG, or RNG derived from the bio-LNG, is provided in a stream that also contains fossil-LNG, or fossil natural gas, respectively. When bio-LNG is used to produce product, the product can be associated with one or more environmental attributes of the RNG used to produce the bio-LNG (e.g., the environmental attributes of the upgraded biogas produced can be transferred through the supply chain). Depending on the process and/or applicable regulations, the use of bio-LNG to produce a product can impart renewable content to the product and/or can reduce a carbon intensity of the product (i.e., relative to the use of fossil-LNG).

In some embodiments, at least some of the bio-LNG is vaporized. In some embodiments, this vaporized gas is injected into a natural gas pipe system and/or is used for producing product (e.g., fuel). In some embodiments, the product is RNG that is delivered via a natural gas pipe system. In some embodiments, the product is compressed-RNG (e.g., compressed to a pressure between about 2900 psig and about 4500 psig).

In some embodiments, at least some of the vaporized gas is used to produce product (e.g., directly or after being moved via a natural gas pipe system), where the product is hydrogen and/or syngas, or is product (e.g., fuel, steel, fertilizer, etc.) produced using the hydrogen and/or syngas. When hydrogen or syngas is produced using bio-LNG or RNG (e.g., RNG derived from the bio-LNG) it can be referred to as “renewable hydrogen” or “renewable syngas,” respectively. Renewable syngas contains renewable hydrogen.

In some embodiments, at least some of the vaporized gas is used to produce renewable hydrogen. In general, the renewable hydrogen can be produced at one or more hydrogen plants. The term “hydrogen plant”, as used herein, refers to a system or combination of systems primarily used for hydrogen production. In general, the hydrogen production can use any suitable technology known in the art that can convert RNG and/or natural gas to hydrogen. Examples of technologies that may be suitable include, but are not limited to, steam methane reforming (SMR), autothermal reforming (ATR), partial oxidation (POX), and dry methane reforming (DMR). SMR, ATR, and DMR, which are types of catalytic reforming, may operate by exposing natural gas to a catalyst at high temperature and pressure to produce syngas. POX reactions, which include thermal partial oxidation reactions (TPOX) and catalytic partial oxidation reactions (CPOX), may occur when a sub-stoichiometric fuel-oxygen mixture is partially combusted in a reformer. POX also may be referred to as oxidative reforming. For purposes herein, the term “methane reforming” can refer to SMR, ATR, DMR, or POX.

Of the various types of methane reforming, SMR is the most common. In SMR, which is an endothermic process, methane is reacted with steam under pressure in the presence of a catalyst to produce carbon monoxide (CO) and H₂ according to the following reaction:

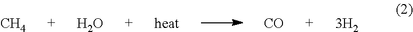

Often this reaction occurs in the SMR reactor tubes, which contain the reforming catalyst. Without being limiting, the catalyst may be nickel-based, the operating pressure may be between 200 psig (1.38 MPa) and 600 psig (4.14 MPa), and the operating temperature may be between about 450 to 1000° C. The heat required for the catalytic reforming of Eq. 2 can be provided by the combustion in the SMR burners (e.g., the combustion chamber may surround the reformer tubes in which the reaction is conducted).

The syngas produced from Eq. (2) may be further reacted in a water gas shift (WGS) reaction, wherein carbon monoxide is converted to carbon dioxide and hydrogen:

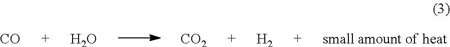

Providing WGS downstream of SMR increases the yield of H₂, and thus is commonly included in hydrogen production. When included, the WGS is considered to be part of the methane reforming.

In addition to methane reforming, the hydrogen production includes hydrogen purification. In hydrogen purification, the syngas (e.g., shifted gas) produced from methane reforming is subjected to processing wherein hydrogen is separated from carbon monoxide, carbon dioxide, and/or methane in one or more stages to produce a stream enriched in hydrogen (i.e., containing at least 80% hydrogen). For example, in some embodiments, the hydrogen purification produces a stream enriched in hydrogen having a hydrogen content of at least 90%, 92%, 94%, 96%, 98%, 99%, or 99.5%. In some embodiments, the hydrogen purification produces a stream enriched in hydrogen having a hydrogen content of at least 99.9%. Without being limiting, some examples of suitable hydrogen purification technologies include, but are not limited to: a) absorption, b) adsorption, c) membrane separation, d) cryogenic separation, and/or e) methanation. Some examples of absorption systems that may be suitable include, but are not limited to, a monoethanolamine (MEA) unit or a methyldiethanolamine (MDEA) unit.

In some embodiments, the vaporized gas is used to produce hydrogen (e.g., directly or after being moved as a fungible batch via a natural gas pipe system). In some embodiments, at least some of the vaporized gas is used to produce renewable hydrogen. In such embodiments, the feed for hydrogen production will include vaporized RNG and can include fossil-natural gas and/or other non-renewable gases such as refinery ga. In some embodiments, renewable hydrogen is produced when the vaporized gas (i.e., at least the RNG) is used either as feedstock that is subjected to methane reforming, or fuel used to provide heat for the SMR (e.g., in the SMR burners).

In some embodiments, at least some of the hydrogen (e.g., renewable hydrogen) is provided for use as fuel. For example, in some embodiments, at least some of the hydrogen (e.g., renewable hydrogen) is used to power fuel cell electric vehicles (FCEVs), produce electricity (e.g., at a power plant), or used as rocket fuel.

In some embodiments, at least some of the vaporized gas is used to produce renewable syngas. Renewable syngas can be produced using, for example, methane reforming such as SMR, ATR, DMR, or POX. In some cases, syngas production can also include WGS, depending on the desired hydrogen to carbon ratio. While renewable syngas can be used directly (e.g., as a fuel), it can be advantageous when the syngas and/or any of its components are provided as an intermediate for producing product (e.g., methanol, DME, Fischer Tropsch fuel, etc.).

In some embodiments, the bio-LNG, vaporized RNG, renewable hydrogen, and/or renewable syngas is a precursor for producing fuel (e.g., methanol, gasoline, diesel, jet fuel, Fischer Tropsch fuel, ammonia, dimethyl ether (DME), or methyl tert-butyl ether (MTBE)). In some embodiments, the bio-LNG, vaporized RNG, and/or hydrogen (e.g., renewable hydrogen) is a precursor for producing transportation fuel. While producing hydrogen (e.g., renewable hydrogen) using bio-LNG for use as fuel is advantageous, it is particularly advantageous when the hydrogen (e.g., renewable hydrogen) is used to produce transportation fuel. For example, using the renewable hydrogen and/or renewable syngas to produce fuel can impart renewable content to fuel and/or can reduce the carbon intensity of the fuel.

In some embodiments, fuel is produced by processing the hydrogen (e.g., renewable hydrogen) with one or more other renewable feedstocks or non-renewable feedstocks. When the process produces fuel from co-processing renewable and non-renewable feedstocks, the fuel can have renewable content.

In some embodiments, the hydrogen (e.g., renewable hydrogen) is used in the hydroprocessing (e.g., hydrocracking and/or hydrotreating) of crude-oil derived liquid hydrocarbon such that at least some of the hydrogen is incorporated into the crude-oil derived liquid hydrocarbon to produce product (e.g., fuel such as gasoline, diesel, and/or jet fuel, or waxes, etc.). In some embodiments, the hydrogen (e.g., renewable hydrogen) is used to produce gasoline, diesel, and/or jet fuel having renewable content. (e.g., see U.S. Pat. Nos. 8,658,026, 8,753,854, 8,945,373, 9,040,271, 10,093,540, 10,421,663, and 10,723,621, 10,981,784). Advantageously, such fuels can replace and/or be used with non-renewable gasoline, diesel, and/or jet fuel without affecting performance and/or operation (e.g., are drop-in fuels). Further advantageously, such fuels can be produced at existing oil refineries using existing equipment. The term “crude oil derived liquid hydrocarbon”, as used herein, refers to any carbon-containing material obtained and/or derived from crude oil that is liquid at standard ambient temperature and pressure. The term “crude oil”, as used herein, refers to petroleum extracted from geological formations (e.g., in its unrefined form). Crude oil includes liquid, gaseous, and/or solid carbon-containing material from geological formations, including oil reservoirs, such as hydrocarbons found within rock formations, oil sands, or oil shale. In some embodiments, renewable hydrogen is used in the hydroprocessing (e.g., hydrocracking and/or hydrotreating) of crude-oil derived liquid hydrocarbon to produce aviation fuel having renewable content. Such embodiments are particularly advantageous as it could help decarbonize commercial air travel and/or extend the life of older aircraft types by lowering their carbon footprint.

In some embodiments, at least some of the hydrogen (e.g., renewable hydrogen) is used in the hydroprocessing (e.g., hydrocracking and/or hydrotreating) of renewable fats and/or oils (e.g., algae, jatropha, tallows, camelina, pyrolysis oil produced from biomass, etc.) to produce gasoline, diesel, and/or jet fuel. This embodiment is particularly advantageous as the resulting fuel can be fully renewable.

In some embodiments, the at least some of the hydrogen (e.g., renewable hydrogen) and/or syngas (e.g., renewable syngas) is used to produce ammonia from a Haber-Bosch process. In the Haber-Bosch process, which is well-known to those skilled in the art, nitrogen is converted to ammonia according to the following reaction:

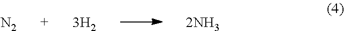

The reaction is conducted under high temperatures and pressures with a metal catalyst. Ammonia has an important role in the agricultural industry for production of fertilizers. Ammonia may also be used as an energy carrier for energy storage and transportation. In some embodiments, the ammonia is used to produce fertilizer.

In some embodiments, at least some of the hydrogen (e.g., renewable hydrogen) and/or syngas (e.g., renewable syngas) is used to produce one or more alcohols via gas fermentation using known processes. In gas fermentation, which is well-known to those skilled in the art, a gas mixture typically containing hydrogen with carbon dioxide and/or carbon monoxide is fed into a fermentation tank. In this embodiment, the carbon monoxide in the syngas functions as a substrate for the biologic conversion, which utilizes microorganisms or other biocatalysts. For example, acetogenic microorganisms can be used to produce a fermentation product from carbon monoxide. The production of ethanol by the acetogenic microorganisms proceeds through a series of biochemical reactions.

In some embodiments, at least some of the hydrogen (e.g., renewable hydrogen) and/or syngas (e.g., renewable syngas) is used to produce methanol (e.g., renewable methanol). For example, methanol can be produced by directly hydrogenating carbon dioxide with hydrogen using Cu/ZnO-based catalysts. Alternatively, hydrogen can be used to produce methanol according to the following reactions:

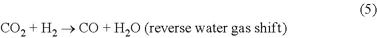

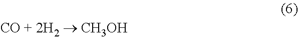

The methanol can be used as a fuel (e.g., mixed with gasoline) or can be used to produce a fuel (e.g., biodiesel).

In some embodiments, at least some of the hydrogen (e.g., renewable hydrogen) and/or syngas (e.g., renewable syngas) is used to produce gasoline, diesel, or waxes using the Fischer-Tropsch process. The Fischer-Tropsch process refers to a collection of chemical reactions that converts syngas into liquid hydrocarbons, typically in the presence of metal catalysts under elevated pressures and temperatures. The Fischer-Tropsch process is well known. In the embodiments including a Fischer-Tropsch process, the hydrogen can be used to supplement another gas feed containing carbon monoxide and/or carbon dioxide in order to provide the required H₂ to CO ratio (e.g., about 2).

Those skilled in the art having the benefit of the teachings herein will appreciate that, is some of these embodiments, renewable hydrogen and/or renewable syngas is provided in a stream that also contains fossil-based hydrogen (i.e., hydrogen produced from fossil resources).

In some embodiments, the bio-LNG is exported and/or transported for use in an industrial-scale plant configured for producing hydrogen, syngas, methanol, ammonia, dimethyl ether (DME), Fischer-Tropsch fuel, and/or fuel produced using other gas-to-liquids (GTL) technology.

In some embodiments, the bio-LNG is stored at and/or transported to: (i) one or more refueling stations (e.g., to fuel road vehicles, ships, locomotives, and/or aircraft), (ii) one or more remote industrial, agricultural, or mining operations (e.g., to be used for heat and power generation, as feedstock for a production process, or to fuel operating equipment such as gas and oil drilling equipment, compressors, etc.), (iii) one or more LNG port terminals or bunkers (e.g., configured for exporting LNG and/or providing LNG fuel for cruise ships or cargo ships), and/or (iv) one or more peak-shaving plants or satellite plants located near a natural gas pipe system (e.g., for ensuring natural gas grid supply reliability).

In some embodiments, the bio-LNG is stored near a natural gas pipe system for periods of peak demand (e.g., at a peak-shaving plant or satellite plant). In some embodiments, the bio-LNG is feedstock for renewable ammonia production, for renewable fertilizer production, for renewable methanol production, and/or renewable diesel production (e.g., using renewable methanol). In some embodiments, the bio-LNG is feedstock for steel production or for an oil refinery.

### Credits

In general, it can be advantageous if the bio-LNG, product produced using the bio-LNG, or the process thereof, is eligible for one or more credits. In some embodiments, credits (e.g., associated with bio-LNG, or product produced using the bio-LNG, or the process) are generated, obtained, or provided. Credits can be used to incentivize renewable products and/or products associated with reduced GHG emissions (e.g., fuels used in the transportation sector). For example, fuel credits can be used to demonstrate compliance with some government initiative, standard, and/or program, where the goal is to reduce GHG emissions (e.g., reduce carbon intensity in transportation fuels as compared to some baseline level related to conventional petroleum fuels) and/or produce a certain amount of biofuel (e.g., produce a mandated volume or a certain percentage of biofuels). The target GHG reductions and/or target biofuel amounts may be set per year or for a given target date. Some non-limiting examples of such initiatives, standards, and/or programs include the Renewable Fuel Standard Program (RFS2) in the United States, the Renewable Energy Directive (RED II) in Europe, the Fuel Quality Directive in Europe, the Renewable Transport Fuel Obligation (RTFO) in the United Kingdom, and/or the Low Carbon Fuel Standards (LCFS) in California, Oregon, or British Columbia).

The term “credit”, as used herein, refers to any rights or benefits relating to carbon or GHG emission reductions, including but not limited to rights to credits, revenues, offsets, GHG gas rights, tax benefits, government payments, or similar rights or benefits, related or arising from emission reductions, trading, or any quantifiable benefits (including recognition, award or allocation of credits, allowances, permits or other tangible rights), whether created from or through a government authority, a private contract, or otherwise. A credit can be a certificate, record, serial number, or guarantee, in any form, including electronic, which evidences production of a quantity of a product (e.g., hydrogen or fuel, fuel intermediate, or product produced using the hydrogen) meeting certain life cycle GHG emission reductions relative to a baseline (e.g., a fossil baseline) set by a government authority. Non-limiting examples of fuel credits include RINs and LCFS credits. A Renewable Identification Number (or RIN), which is a certificate that acts as a tradable currency for managing compliance under the RFS2, may be generated for each gallon of biofuel (e.g., ethanol, biodiesel, etc.) produced. A Low Carbon Fuel Standard (LCFS) credit, which is a certificate which acts as a tradable currency for managing compliance under California's LCFS, may be generated for each metric ton (MT) of CO₂ reduced. Credits for clean or low CI hydrogen may be set by the appropriate regulatory authority and provided in many forms, e.g., producer or production credits and the like. In some embodiments, the method(s) includes generating, obtaining, or providing producer or production credits for clean hydrogen or credits for products made using clean hydrogen.

In general, the requirements for generating or causing the generation of credits can vary by country, the agency, and or the prevailing regulations in/under which the credit is generated. In some cases, credit generation may be dependent upon a compliance pathway (e.g., predetermined or applied for) and/or the product (e.g., hydrogen and/or fuel, fuel intermediates, or products produced from the hydrogen) meeting a predetermined GHG emission threshold. For example, with regard to the former, the RFS2 categorizes biofuel as cellulosic biofuel, advanced biofuel, renewable biofuel, and biomass-based diesel. With regard to the latter, to be a renewable biofuel under the RFS2, corn ethanol should have lifecycle GHG emissions at least 20% lower than an energy-equivalent quantity of gasoline (e.g., 20% lower than the 2005 EPA average gasoline baseline of 93.08 gCO₂e/MJ). In low carbon-related fuel standards, biofuels may be credited according to the carbon reductions of their pathway. For example, under California's LCFS, each biofuel is given a carbon intensity score indicating their GHG emissions as grams of CO₂ equivalent per megajoule (MJ) of fuel, and credits are generated based on a comparison of their emissions reductions to a target or standard that may decrease each year (e.g., in 2019, ethanol was compared to the gasoline average carbon intensity of 93.23 gCO₂e/MJ), where lower carbon intensities generate proportionately more credits.

### EXAMPLE

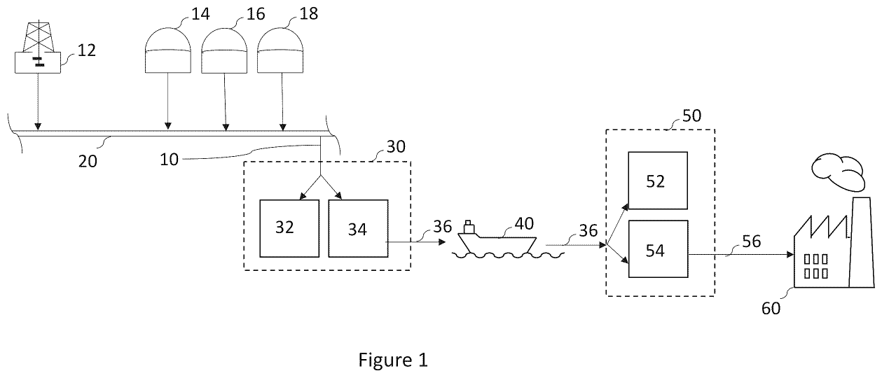

Referring to FIG. 1, there is shown an embodiment of a method for producing product. A methane-containing feed 10 is withdrawn from a natural gas pipe system 20 for a process for producing liquefied gas 30 (e.g., fossil-LNG and/or bio-LNG). The methane-containing feed 10 contains fossil natural gas, which is extracted from one or more fossil reserves 12 and RNG. In this embodiment, the RNG contains three batches of RNG, namely, a first batch of RNG sourced from a landfill 14 and having a carbon intensity of about 40 gCO₂e/MJ, a second batch of RNG sourced from a first anaerobic digestion 16 and having a carbon intensity of about 10 gCO₂e/MJ, and a third batch of RNG sourced from a second anaerobic digestion 18 and having a carbon intensity of about −70 gCO₂e/MJ. FIG. 1 shows upgraded biogas from each of the sources 14, 16, 18 being injected into the pipe system 20 at individual injection points, however, it is also possible to use one or more centralized injection points.

The RNG makes up 10% of the total methane-containing feed 10, with the remaining feed being natural gas. The first batch of RNG makes up 70% of the total RNG provided, the second batch of RNG makes up 20% of the total RNG provided, and the third batch of RNG makes up 10% of the total RNG provided, such that the weighted-average carbon intensity of the RNG in the methane-containing feed 10 is 23 gCO₂e/MJ.

The methane-containing feed 10 is split into a first portion that is fuel 32 to be combusted to produce heat and/or power for the liquefaction process 30, and a second portion that is feedstock 34 for the liquefaction process. For example, the first portion 32 can include natural gas liquids separated out from the methane-containing feed 10 (e.g., during part of a precleaning) and/or tail gas from the precleaning. Of the total methane-containing feed 10, the fuel 32 makes up 15% while the feedstock 34 for liquefaction makes up 85%. Without specifically allocating the RNG between fuel and feedstock, the liquefaction process 30 will produce bio-LNG and fossil-LNG, with the bio-LNG making up 10% of the total liquefied gas produced (on an energy basis).

At least a portion of the liquefied gas 36 (e.g., at least some of the bio-LNG, and optionally some or all of the fossil-LNG) is shipped 40. For example, the liquefied gas 36 can be shipped overseas on an LNG carrier. In this embodiment, the transported liquefied gas 36 is regasified 50 to produce vaporized gas. The bio-LNG can be regasified close to the port and injected into a natural gas pipe system for transport to the production process 60, or can be transported by road and/or rail to the regasification plant, which is either located close to the production process 60 or is connected to a natural gas pipe system configured to provide vapourized gas (e.g., natural gas and/or RNG) to the production process 60. In this embodiment, the liquefied gas feed 36 is split between a first portion that is feedstock 54 for the regasification process 50 and a second portion that is fuel 52 used to produce heat and/or power for the regasification process 50. At least a portion of the vaporized gas 56 (e.g., at least the vaporized RNG) is used in the production process 60 (e.g., optionally after being transported as a fungible batch in a natural gas pipe system). In general, the process to produce product 60 can produce any suitable product (e.g., hydrogen, ammonia, gasoline, diesel, jet fuel, methanol, dimethyl ether (DME), methyl tert-butyl ether (MTBE), fertilizer, electricity, and/or steel).

In order to increase the amount of bio-LNG produced from the RNG in the methane-containing feed 10, to increase the amount of vaporized RNG produced, and/or to reduce the carbon intensity of the bio-LNG, vaporized RNG, and/or product, the RNG in the methane-containing feed 10 is distributed disproportionately between fuel 32 and feedstock 34 and/or the bio-LNG in the liquefied feed 36 is distributed disproportionately between fuel 52 and feedstock 54.

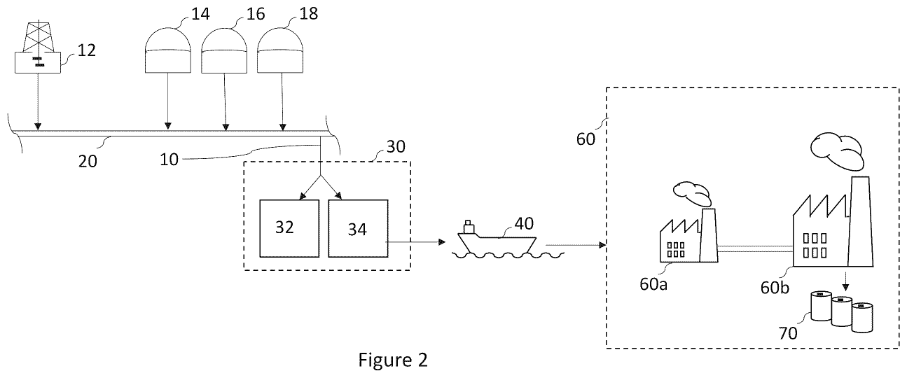

Referring to FIG. 2, there is shown another embodiment of a method of producing product. This embodiment is similar to the process shown in FIG. 1, except that the production process 60 includes hydrogen production 60a and fuel production 60b, and produces fuel 70 having renewable content (e.g., gasoline and/or diesel). For illustrative purposes, the regasification process is not shown.

The hydrogen production 60a can occur at a stand-alone hydrogen plant or a hydrogen plant located at the fuel production facility. The hydrogen produced can be provided via a hydrogen pipe system. In general, the hydrogen, which is produced using the vaporized gas (e.g., at least the RNG, and optionally some or all of the fossil natural gas), can have a carbon intensity that is relatively low compared to hydrogen produced using only non-renewable feedstock (e.g., fossil natural gas and/or refinery gas).

The fuel production 60b uses at least some of the hydrogen in the hydroprocessing (e.g., hydrocracking and/or hydrotreating) of crude-oil derived liquid hydrocarbon. Accordingly, the carbon intensity of the resulting fuel 70 can be reduced. In some embodiments, the hydrogen produced from hydrogen production produces renewable hydrogen, which is incorporated into crude-oil derived liquid hydrocarbon. In such embodiments, the fuel (e.g., gasoline and/or diesel) is produced using both renewable feedstock (e.g., RNG and/or renewable hydrogen) and non-renewable feedstock (e.g., crude-oil derived liquid hydrocarbon), and as a result, the fuel (e.g., gasoline and/or diesel) can be treated as having renewable content. The renewable content, can for example, be quantified as a renewability, as proposed in the “RTFO Guidance Part One Process Guidance”, version January 2020, used for reporting under the Renewable Transport Fuel Obligations Order 2007 No. 3072. In this case, the renewability of a fuel refers to the percentage of a fuel (by energy) that is recognized as and/or treated as renewable, and is calculated using Eq. 7.

$$MJ of renewable fuel = \frac{Total MJ of renewable feedstocks}{Total MJ of all feedstocks} * Total MJ of fuel produced \qquad ( 7 )$$

This approach for determining renewable content may be particularly suitable for fuels produced by hydrogenating crude-oil derived liquid hydrocarbon with renewable hydrogen, as part of the energy of the fuel is from renewable sources and part is from non-renewable sources. As will be appreciated by those skilled in the art, other quantification methods can be used (e.g., selected in dependence on the applicable regulations). As such a fuel may not have discrete volumes that are renewable or non-renewable, in order to determine how much of the fuel contains renewable content that is eligible for incentives under applicable regulations, the volume of the fuel(s) produced can be split into notional non-renewable and renewable portions.

Unfortunately, in some cases, the renewable content can have a carbon intensity that is too high for it to be eligible as a qualifying renewable fuel. For example, Under RED II, transport biofuels such as gasoline and/or diesel typically have to achieve GHG emissions reduction of 65% relative to a fossil comparator (e.g., 94 gCO₂/MJ). Accordingly, the carbon intensity of the renewable content of the gasoline and/or diesel may need to be lower than about 32.9 gCO₂/MJ in order to be a qualifying renewable fuel under RED II. This threshold may be challenging to meet when the weighted-average carbon intensity of the RNG is greater than about 10 to 15 gCO₂e/MJ or greater than about 20 gCO₂e/MJ (e.g., depending on the liquefaction process, regasification process, and/or fuel production process).

In order to reduce the carbon intensity of the renewable content (e.g., of gasoline and/or diesel), the RNG is distributed disproportionately between feedstock 34 and fuel 32 (e.g., for liquefaction) and/or the bio-LNG is distributed disproportionately between feedstock 54 and fuel 52 (e.g., for regasification). For example, the RNG can be distributed such that the feedstock for liquefaction contains all of the first batch of RNG and half the second batch of RNG (e.g., such that the RNG in the feedstock has a weighted-average carbon intensity of 36.25 gCO₂e/MJ), whereas the fuel contains half of the second batch of RNG and all of the third batch of RNG (e.g., such that the RNG in fuel has a weighted-average carbon intensity of −30 gCO₂e/MJ).

In this embodiment, the disproportionate distribution decreases the quantity of the bio-LNG produced (e.g., relative to a proportionate distribution), but also reduces the carbon intensity of the bio-LNG produced (e.g., relative to a proportionate distribution). In some cases, the carbon intensity reduction may be sufficient such that the quantity of gasoline and/or diesel derived from the bio-LNG that is treated as a qualified renewable fuel (e.g., meets the 32.9 gCO₂/MJ threshold) is increased (e.g., relative to that obtained with a proportionate distribution).

It has now been found that it can be advantageous to distribute a batch of RNG having a relatively low carbon intensity (e.g., produced from manure) for use as fuel (e.g., 32 or 52), because even if it is only available in small quantities it can have a significant effect on the carbon intensity of the bio-LNG or product produced even when used in small quantities and/or blended with non-renewable natural gas. For example, when a given RNG is designated as fuel for the liquefaction, its carbon emissions can affect the carbon intensity of all of the liquefied gas produced, even when the liquefied gas is produced from different feedstocks. It has also been found that providing feedstock and fuel having RNG with different weighted average carbon intensities can be advantageous over approaches that simply treat carbon emission reductions from multiple RNGs as cumulative and/or independent of where they are used.

Of course, the above embodiments have been provided as examples only. It will be appreciated by those of ordinary skill in the art that various modifications, alternate configurations, and/or equivalents will be employed without departing from the scope of the invention. Accordingly, the scope of the invention is therefore intended to be limited solely by the scope of the appended claims.

The terminology used herein is for the purpose of describing certain embodiments only and is not intended to be limiting of the invention. For example, as used herein, the singular forms “a,” “an,” and “the” may include plural references unless the context clearly dictates otherwise. The terms “comprises”, “comprising”, “including”, and/or “includes”, as used herein, are intended to mean “including but not limited to.” The term “and/or”, as used herein, is intended to refer to either or both of the elements so conjoined. The terms “remove”, “removing”, and “removal”, with reference to one or more impurities, contaminants, and/or constituents of biogas, includes partial removal. The term “associated with”, as used herein with reference to two elements (e.g., a fuel credit associated with the transportation fuel), is intended to refer to the two elements being connected with each other, linked to each other, related in some way, dependent upon each other in some way, and/or in some relationship with each other. The terms “first”, “second”, etc., may be used to distinguish one element from another, and these elements should not be limited by these terms. The term “providing” as used herein with respect to an element, refers to directly or indirectly obtaining the element and/or making the element available for use. Unless defined otherwise, all technical and scientific terms used herein have the same meanings as commonly understood by one of ordinary skill in the art.

1. A method of producing liquefied renewable natural gas, the method comprising:
withdrawing gas from at least one natural gas pipe system, the gas comprising fossil natural gas and renewable natural gas;
providing a first portion of the withdrawn gas to be liquefied;
providing a second portion of the withdrawn gas for generating heat, power, or a combination thereof; and
subjecting the first portion to a liquefaction process, thereby producing liquefied gas, at least some of the heat, power, or combination thereof generated from the second portion used in the liquefication process,
wherein the first portion comprises at least some of the renewable natural gas such that the liquefied gas comprises liquefied renewable natural gas,
wherein the renewable natural gas is distributed disproportionately between the first and second portions, and
wherein the disproportionate distribution: (i) increases a quantity of the liquefied renewable natural gas produced relative to when the renewable natural gas is distributed proportionately between the first and second portions, (ii) reduces a carbon intensity of the liquefied renewable natural gas produced relative to when the renewable natural gas is distributed proportionately between the first and second portions, or (iii) a combination of (i) and (ii).

2. The method according to claim 1, wherein the second portion comprises some of the renewable natural gas.

3. The method according to claim 2, wherein the disproportionate distribution provides the first portion with a different renewable fraction than the second portion.

4. The method according to claim 3, wherein the disproportionate distribution provides the first portion with a higher renewable fraction than the second portion.

5. The method according to claim 3, wherein the renewable natural gas in the first and second portions has a same carbon intensity.

6. The method according claim 1, wherein the disproportionate distribution increases the quantity of the liquefied renewable natural gas produced relative to when the renewable natural gas is distributed proportionately between the first and second portions.

7. The method according to claim 2, wherein the renewable natural gas is sourced from multiple biogas sources, and wherein the disproportionate distribution provides the renewable natural gas in the first and second portions with different weighted-average carbon intensities.

8. The method according to claim 7, wherein the renewable natural gas in the second portion has a lower weighted-average carbon intensity than the renewable natural gas in the first portion.

9. The method according to claim 1, wherein the disproportionate distribution reduces a carbon intensity of the liquefied renewable natural gas produced relative to when the renewable natural gas is distributed proportionately between the first and second portions.

10. The method according to claim 1, wherein the disproportionate distribution increases a quantity of credits for which the liquefied renewable natural gas, product produced using the liquefied renewable natural gas, or any combination thereof, is eligible for relative to when the renewable natural gas is distributed proportionately between the first and second portions.

11. The method according to claim 1, wherein the second portion is combusted to generate power, the power generating electricity or driving equipment used in the liquefaction process.

12. The method according to claim 1, further comprising:
(a) transporting at least some of the liquefied renewable natural gas, and
(b) subjecting at least some of the transported liquefied renewable natural gas to a regasification process, thereby providing vaporized renewable natural gas.

13. The method according to claim 12, further comprising providing at least some of the transported liquefied renewable natural gas as fuel for generating heat, power, or a combination thereof, the heat, power, or combination thereof used within the regasification process.

14. The method according to claim 13, wherein feedstock for the regasification process has at least one characteristic that is distinct from that of the fuel for generating heat, power, or combination thereof, the at least one characteristic including at least one of renewable fraction or carbon intensity of the renewable natural gas therein.

15. The method according to claim 1, wherein the liquefied renewable natural gas is used to produce fuel, and wherein the fuel comprises at least one of compressed renewable natural gas, syngas, hydrogen, ammonia, gasoline, diesel, jet fuel, methanol, dimethyl ether (DME), or methyl tert-butyl ether (MTBE).

16. The method according to claim 15, wherein the disproportionate distribution is selected to increase a quantity of fuel produced using the liquefied renewable natural gas that is treated as a qualifying renewable fuel, is treated as meeting a certain carbon intensity threshold, or a combination thereof, relative to when the RNG is distributed proportionately between the first and second portions.

17. The method according to claim 1, wherein a weighted-average carbon intensity of the renewable natural gas is 20 gCO₂e/MJ or higher.

18. The method according to claim 1, wherein the liquefied renewable natural gas is provided for use as transportation fuel, the transportation fuel comprising at least one of marine fuel and truck fuel.

19. (canceled)

20. (canceled)

21. A method of providing product, the method comprising:
determining a supply chain for providing liquefied renewable natural gas or vaporized renewable natural gas to an end user, the supply chain including:
(i) sourcing upgraded biogas that is introduced into a first natural gas pipe system,
(ii) producing liquefied renewable natural gas using renewable natural gas associated with one or more environmental attributes of the upgraded biogas, and
(iii) producing vaporized renewable natural gas using the liquefied renewable natural gas in a regasification process, the vaporized renewable natural gas associated with the one or more environmental attributes of the upgraded biogas; and
producing product associated with the environmental attributes of the upgraded biogas, the product being the liquefied renewable natural gas or vaporized renewable natural gas provided to the end user, or being product produced using the liquefied renewable natural gas or vaporized renewable natural gas provided to the end user,
wherein the renewable natural gas used to produce the liquefied renewable natural gas in (ii), the liquefied renewable natural gas provided to the regasification in (iii), or a combination thereof, is distributed disproportionately between: (a) a supply chain portion of the corresponding fluid, and (b) a fuel portion of the corresponding fluid.

22. A method of producing liquefied renewable natural gas, the method comprising:
withdrawing gas from at least one natural gas pipe system, the gas comprising renewable natural gas and fossil natural gas;
providing a first portion of the withdrawn gas to be liquefied;
providing a second portion of the withdrawn gas for generating heat, power, or a combination thereof;
subjecting the first portion to a liquefaction process, thereby producing liquefied gas, at least some of the heat, power, or combination thereof generated from the second portion used in the liquefication process, the first portion comprising at least some of the renewable natural gas such that the liquefied gas produced comprises liquefied renewable natural gas; and
distributing the renewable natural gas between the first and second portions such that the first portion has at least one characteristic that is distinct from that of the second portion, the at least one characteristic including at least one of renewable fraction or carbon intensity of the renewable natural gas therein.

23. (canceled)

24. A method of producing fuel, the method comprising:
producing fuel from a fuel production process that comprises hydrogenating crude-oil derived liquid hydrocarbon in one or more hydroprocessing units using renewable hydrogen, the fuel having renewable content,
the renewable hydrogen produced from a hydrogen production process comprising methane reforming, at least some of a methane-containing fluid fed to the methane reforming produced in a process comprising:
(a) withdrawing gas from at least one natural gas pipe system, the gas comprising renewable natural gas and fossil natural gas;
(b) providing a first portion of the withdrawn gas to be liquefied;
(c) providing a second portion of the withdrawn gas for generating heat, power, or a combination thereof;
(d) subjecting the first portion to a liquefaction process, thereby producing liquefied gas, at least some of the heat, power, or combination thereof generated from the second portion used in the liquefication process, the first portion comprising at least some of the renewable natural gas such that the liquefied gas produced comprises liquefied renewable natural gas; and
(e) distributing the renewable natural gas disproportionately between the first and second portions,
wherein the renewable natural gas has a carbon intensity sufficiently high that the renewable content is not eligible for one or more credits when the renewable natural gas is distributed proportionately between the first and second portions, and
wherein the disproportionate distribution is selected to reduce lifecycle greenhouse (GHG) emissions of the renewable content to an extent that the renewable content is eligible for the one or more credits.

25. (canceled)
